(19) United States
(12) Patent Application Publication
(10) Pub. No.: US 2008/0248413 A1
(43) Pub. Date: Oct. 9, 2008

(54) LIQUID DEVELOPING AGENT, METHOD OF PRODUCING THE SAME AND METHOD OF PRODUCING DISPLAY DEVICE

(76) Inventors: Keita Ishii, Kokubunji-shi (JP); Yasushi Shinjo, Kawasaki-shi (JP); Hirofumi Takemura, Kamakura-shi (JP); Katsuyuki Aoki, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/054,705

(22) Filed: Mar. 25, 2008

Related U.S. Application Data
(63) Continuation of application No. PCT/JP2007/068866, filed on Sep. 27, 2007.

(30) Foreign Application Priority Data
Sep. 29, 2006 (JP) 2006-269402
Mar. 27, 2007 (JP) 2007-082781
Mar. 28, 2007 (JP) 2007-085717

(51) Int. Cl. G03G 9/08; G03G 13/04

(52) U.S. Cl. 430/48; 430/115; 430/137.22

(57) ABSTRACT

On the surface of a core particle of a toner particle, a silane coupling agent treatment layer, a coating layer of thermoplastic resin microparticles applied to the core particle and a charge control agent added to the coating layer through the silane coupling agent treatment layer are provided, wherein the toner particle has a particle diameter of 1 to 10 μm, or on the surface of a core particle of a toner particle, a coating layer of thermoplastic resin microparticles and a charge control agent added to the coating layer and made of an organic compound containing at least one type of lanthanoid metal are provided, or on a ZnS type fluorescent body core particle, a coating layer of thermoplastic resin microparticles and a charge control agent added to the coating layer and including a metal compound containing the IIA metal or IIIA group metal are provided.

### CROSS REFERENCE TO RELATED APPLICATIONS

This is a Continuation Application of PCT Application No. PCT/JP2007/068866, filed Sep. 27, 2007, which was published under PCT Article 21(2) in Japanese.

This application is based upon and claims the benefit of priority from prior Japanese Patent Applications No. 2006-269402, filed Sep. 29, 2006; No. 2007-082781, filed Mar. 27, 2007; and No. 2007-085717, filed Mar. 28, 2007, the entire contents of all of which are incorporated herein by reference.

### BACKGROUND OF THE INVENTION

1. Field of the Invention

The present invention relates to a method of producing a display device such as a plasma display and field emission display, a liquid developing agent used in these displays and a method of producing the liquid developing agent.

2. Description of the Related Art

Photolithographic technologies have played a central role as technologies for forming fine patterns on the surface of a base material. However, while these technologies are more and more improved in resolution and performance, they require a huge and expensive production facility, with the production cost rising with the resolution.

On the other hand, in the field of production of image display devices, as well as semiconductor devices, there are increasing needs for improved performance and cost reduction. However, the photolithographic technologies described above can no longer meet such needs.

In such a situation, attention has been focused on pattern formation technologies using digital printing technologies. For example, ink jet technologies have started to be put into practical use by making use of the characteristics such as the simplicity of the equipment and non-contact patterning. However, there are limitations to improvements in resolution and productivity.

In the meantime, electrophoretic technologies including, for example, electrophotographic technologies using a liquid toner, have excellent potential with respect to a reduction in cost and improvements in resolution and productivity. As disclosed in, for example, Jpn. Pat. Appln. KOKAI Publication No. 9-202995, there is a proposal regarding technologies using such electrophoretic technologies to form a fluorescent body layer of the front substrate for a flat panel display. In this method, a resin constituted of a core part, which is insoluble or is swollen in an insulation solvent, and an outside peripheral part, which is swollen or dissolved in the insulation solvent, is used as a resin component for a fluorescent body toner.

However, it is necessary to use a good solvent capable of dissolving the resin completely and sufficiently when toner particles are produced. Therefore, not only must a volatile organic solvent other than an insulation solvent be used but also a resin having a controlled SP value must be designed, which therefore makes it difficult to control the intrinsic characteristics of the toner such as charging ability, adhesiveness and coagulation ability, which strictly limits the range of material selectable.

Also, in this liquid toner, a dispersant and a charge control agent are added to impart dispersibility and charging ability in the electrodeposition solution.

For attaining high resolution, it is important to control the behavior of individual toner particles and it is also an important factor to control the charging ability of toner particles in the case of using electrophoretic technologies.

Here, in order to control the charging ability of toner particles by using a charge control agent, the interaction of the charge control agent on the surface of the toner particles is important, and the charging ability largely varies depending on the surface condition of the toner particles. When, for example, the toner particles are coated with a resin upon use, it is difficult to control the surface coated with the resin in a uniform state, and it is therefore difficult to control the charging ability of individual toner particles, bringing about a difficulty in highly precise patterning.

Moreover, when a metal type compound is used as the charge control agent, it is necessary to consider the influence on the characteristics of a mother body. Especially, in fluorescent bodies in which ZnS (zinc sulfide) is used as each mother body and is used in the fluorescent plane of, for example, a cathode ray tube (CRT) and field emission display (FED), transition metals such as the ferrous metals which enter the emission site of the ZnS mother body, thereby deteriorating the emitting characteristics of the fluorescent body, are known as killer materials. This fatal deterioration in emitting characteristics is therefore a key hurdle to the development of a highly luminescent and long life fluorescent body for image display devices. Therefore, the materials that can be used as the charge control agent are limited and thus, an electrophoretic ability sufficient for a liquid developing agent is not obtained, with the result that it is difficult to accomplish highly precise patterning by using electrophoretic technologies.

### BRIEF SUMMARY OF THE INVENTION

The present invention has been made in view of such a problem, and it is an object thereof to provide a liquid developing agent which is superior in charging ability and dispersibility, which enables forming a toner layer with high resolution and high precision.

According to a first aspect of the present invention, there is provided a liquid developing agent comprising:

an electric insulation solvent; and

toner particles included in the electric insulation solvent and containing core particles having an average particle diameter of 1 to 10 μm, a silane coupling agent treatment layer disposed on the surface of the core particle, a coating layer of thermoplastic resin microparticles disposed on the surface of the core particle through the silane coupling agent treatment layer and a charge control agent added to the surface of the core particle coated with the thermoplastic resin microparticles.

According to a second aspect of the present invention, there is provided a method of producing a liquid developing agent, the method comprising:

carrying out a silane coupling treatment on a surface of core particles having an average particle diameter of 1 to 10 μm to form a silane coupling agent treatment layer;

stirring, in an electric insulation solvent, the core particles treated by the silane coupling treatment and thermoplastic resin microparticles which are substantially insoluble in the electric insulation solvent and have a smaller average particle diameter than the core particle at a temperature less than the boiling point of the electric insulation solvent to make the thermoplastic resin microparticles stick to the surface of the core particle treated by silane coupling treatment, thereby forming a coating layer of thermoplastic resin microparticles; and

applying a charge control agent to the electric insulation solvent containing the core particles coated with the thermoplastic resin microparticles to add the charge control agent to the surface of the core particle coated with the thermoplastic resin microparticles.

According to a third aspect of the present invention, there is provided a method of producing a display device, the method comprising a process of forming a front substrate, the process comprising:

forming a light shielding layer having a plurality of frame or stripe patterns;

developing to supply a liquid developing agent including an electric insulation solvent and toner particles included in the electric insulation solvent and containing core particles having an average particle diameter of 1 to 10 μm, a silane coupling agent treatment layer disposed on the surface of the core particle, a coating layer of thermoplastic resin microparticles disposed on the surface of the core particle through the silane coupling agent treatment layer and a charge control agent added to the surface of the core particle coated with the thermoplastic resin microparticles, to the surface of an image support through a supply member, and forming an electric field between the supply member and the image support to form a dot or stripe pattern image on the surface of the image support;

rolling the image support on which a pattern image has been formed using the liquid developing agent along a transparent substrate held at a fixed position and having a light-shielding layer;

transferring to form an electric field between the rolled image support and the transparent substrate and transferring the pattern image disposed on the surface of the image support to the transparent substrate to form a fluorescent body layer on each region on the substrate partitioned by the light-shielding layer; and

forming a metal back layer on the fluorescent body layer.

According to a forth aspect of the present invention, there is provided a liquid developing agent comprising:

an electric insulation solvent; and

toner particles included in the electric insulation solvent and containing core particles, a coating layer of thermoplastic resin microparticles disposed on the surface of the core particle and an organic metal compound containing at least one lanthanoid metal and added as a charge control agent to the surface of the core particle coated with the thermoplastic resin microparticles.

According to a fifth aspect of the present invention, there is provided a liquid developing agent comprising:

an electric insulation solvent; and

toner particles included in the electric insulation solvent and containing core particles made of a zinc sulfide type fluorescent body, a coating layer of thermoplastic resin microparticles disposed on the surface of the core particle and a metal compound containing at least one of IIA group and IIIA group metals and added as a charge control agent to the surface of the core particle coated with the thermoplastic resin microparticles.

### BRIEF DESCRIPTION OF THE SEVERAL VIEWS OF THE DRAWING

FIG. 1 is a typical sectional view showing the structure of toner particles in a liquid developing agent according to the present invention.

FIG. 2 is a flow diagram of a method of producing the liquid developing agent according to the present invention.

FIG. 3 is a view showing the appearance of an example of a pattern formation device used in a process of forming a front substrate.

FIG. 4A is a plan view showing a master plate used in the pattern formation device shown in FIG. 3.

FIG. 4B is a sectional view showing the master plate used in the pattern formation device shown in FIG. 3.

FIG. 5 is a partially enlarged plan view showing the master plate shown in FIG. 4A.

FIG. 6 is a partially enlarged perspective view for explaining the structure of one concave part of the master plate shown in FIG. 4B.

FIG. 7 is a schematic view showing the state of the master plate shown in FIG. 4A which is wound around a drum bare pipe.

FIG. 8 is a schematic view showing the structure for electrifying the surface of a high-resistance layer of the master plate shown in FIG. 4B.

FIG. 9 is a schematic view showing the structure for forming a pattern using toner particles by supplying a liquid developing agent to the master plate in FIG. 4A.

FIG. 10 is a schematic view showing the structure for transferring a pattern formed on the master plate shown in FIG. 4A to a glass plate.

FIG. 11 is a schematic view showing the structure of an essential part of a rolling mechanism that rolls the master plate shown in FIG. 4A along a glass plate.

FIG. 12 is for showing the action exerted to transfer toner particles collected in a concave portion of the master plate to a glass plate.

FIG. 13 is a typical sectional view showing an example of the front substrate according to the present invention.

FIG. 14 is a perspective view showing an example of an FED used as a display device according to the present invention.

FIG. 15 is a sectional view along the line A-A′ of FIG. 14.

FIG. 16 is a schematic view showing an example of a test instrument usable in the present invention.

FIG. 17 is a schematic view showing an example of a test instrument that forms a toner layer by using a liquid developing agent.

FIG. 18 is a SEM photograph showing the surface structure of toner particles.

FIG. 19 is a SEM photograph showing the surface structure of toner particles.

FIG. 20 is a model diagram for explaining an example of the structure of toner particles contained in the liquid developing agent according to the present invention.

FIG. 21 is a typical sectional view showing the structure of toner particles contained in the liquid developing agent according to the present invention.

FIG. 22 is a typical view showing the structure of a sample for measuring the emission characteristics.

FIG. 23 is a graph showing the emission luminances of the fluorescent planes formed using various liquid developing agents.

FIG. 24 is a graph showing the relationship between the dose of electron rays applied to the fluorescent planes and the emission luminance of the fluorescent planes formed using various liquid developing agents.

FIG. 25 is a graph showing the emission luminances of the fluorescent planes formed using various liquid developing agents.

FIG. 26 is a graph showing the relationship between the dose of electron rays applied to the fluorescent planes and the emission luminance of the fluorescent planes formed using various liquid developing agents.

### DETAILED DESCRIPTION OF THE INVENTION

The present invention includes the following five inventions.

A liquid developing agent according to a first invention includes an electric insulation solvent and toner particles.

This toner particle is provided with a core particle, a silane coupling agent treatment layer formed on the surface of the core particle, a coating layer formed of thermoplastic resin microparticles on the core particle, and a charge control agent added to the coating layer through the silane coupling agent treatment layer, and has a particle diameter of 1 to 10 μm.

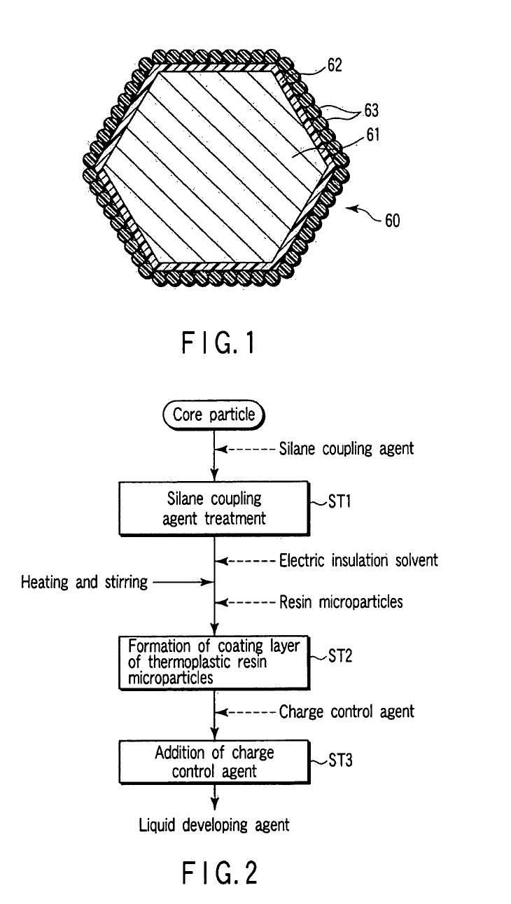

FIG. 1 shows a typical sectional view showing the structure of toner particles in the liquid developing agent according to the present invention.

As illustrated, in this toner particle 60, resin microparticles 63 are stuck to a core particle 61 provided with a silane coupling layer 2 on the surface thereof, through a silane coupling agent treatment layer 62 to form a coating layer.

Here, the coating layer covers at least a part of the surface of the toner particle.

The liquid developing agent according to the first invention can be produced by a method of producing a liquid developing agent according to the first invention.

In such a method of producing a liquid developing agent, the core particle is surface-treated with a silane coupling agent in advance and thermoplastic resin microparticles are stirred under heating in an electrically insulated solvent at a temperature equal to or less than the boiling point of the insulation solvent together with the core particle to stick the thermoplastic resin microparticles to the surface of the core particle with the silane coupling agent treatment layer interposed therebetween. In succession, a charge control agent is applied to the electric insulation solvent containing the core particle coated with the thermoplastic resin microparticles to thereby add the charge control agent to the core particle coated with the thermoplastic resin microparticles.

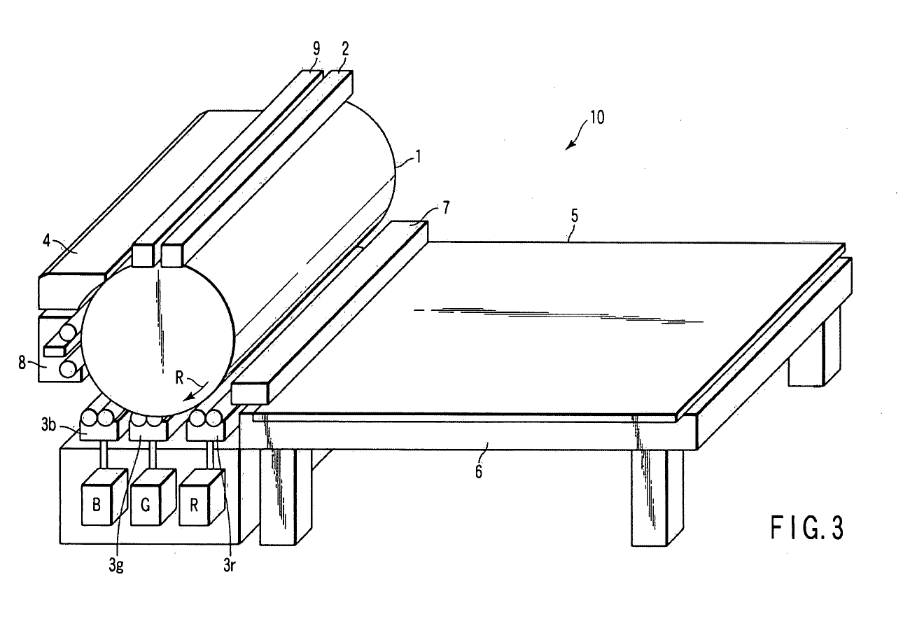

FIG. 2 shows a flow diagram of the method of producing a liquid developing agent according to the present invention.

As illustrated, first, the silane coupling agent is added to the core particle to carry out a silane coupling treatment on the surface of the core particle (ST1). Next, the electric insulation solvent and the thermoplastic resin microparticles are added to the core particle treated by the silane coupling treatment, and the mixture is then stirred under heating at a temperature equal to or less than the boiling point of the electric insulation solvent. The thermoplastic resin microparticles are thereby made to adhere to the surface of the core particle with the silane coupling agent interposed therebetween to form a coating layer of thermoplastic resin microparticles (ST2). Moreover, a charge control agent is added to the electric insulation solvent containing the core particle coated with the thermoplastic resin microparticles (ST3). In this manner, a liquid developing agent according to the first invention is obtained.

Generally, even if the thermoplastic resin microparticles are applied directly to the surface of the core particle, the thermoplastic resin microparticles are scarcely stuck to the surface of the core particle. Even if, for example, a hydrophilic fluorescent body is used as the core particle and hydrophobic thermoplastic resin microparticles are applied thereto, the thermoplastic resin microparticles are scarcely stuck to the core particle. However, according to the present invention, the core particle is surface-treated with the silane coupling agent in advance, whereby the silane coupling agent treatment layer functions as a binder to create an affinity between the core particle and the thermoplastic resin microparticles, with the result that the thermoplastic resin microparticles can be uniformly stuck to the surface of the core particle. For this reason, it is unnecessary to apply other binders such as wax to the surface of the core particle in the present invention. If, for example, wax is contained in the coating layer, the charging ability of toner particles tends to be deteriorated by the wax bled on the surface of the toner particles. In the present invention, on the other hand, the thermoplastic resin microparticles are present uniformly on the surface of the toner particles and therefore, the charging ability is greatly improved.

According to the method of producing a liquid developing agent according to the present invention, a liquid developing agent can be produced without carrying out complicated operations merely by supplying raw materials in a container capable of receiving a solvent and by carrying out basic operations relating to the temperature of the system and stirring. Also, the method of the present invention precludes the necessity of a large-scale and complicated apparatus and is therefore inexpensive and simple.

Also, because the addition of extra organic components such as wax is prevented as mentioned above, a process of removing a binder (thermal process) after the thick toner layer is formed can be eliminated, making it possible to attain a substantial cost reduction.

The adsorbing ability of the charge control agent to the toner particle can be controlled by controlling the amount of the thermoplastic resin microparticles to be coated on the core particle which is surface-treated with a silane coupling agent, whereby the charging ability of the toner particle can be regulated. The control of the coating amount of the thermoplastic resin microparticles leads to the result that the adhesion and coagulation ability of the toner particle can be regulated.

The concentration of the silane coupling agent solution used to carry out the uniform surface treatment of the core particle, water-alcohol solution or aqueous acetic solution having a pH of about 4 may be 0.01% by weight to 5% by weight.

When the concentration is less than 0.01% by weight, the surface of the core particle cannot be sufficiently treated by silane coupling treatment and therefore, the thermoplastic resin microparticles tend to be insufficiently stuck to the core particle, whereas when the concentration exceeds 5% by weight, there is too much silane coupling agent to be dissolved in the solvent, which can lead to uneven treatment or coagulation.

The ratio by weight of the toner particles to the insulation solvent may be designed to be 2:98 to 50:50 with respect to 100 parts by weight of the liquid developing agent.

If the ratio by weight is out of the above range, a large amount of solvent is required to obtain a prescribed film thickness and also, there is a tendency that the toner particles adhere to parts other than the pattern where a film is to be formed, causing contamination.

Also, according to an embodiment of the present invention, the charge control agent may be added in an amount of 1 part by weight to 50 parts by weight to the toner particles based on the core particles.

Also, according to another embodiment of the present invention, the amount of the thermoplastic resin microparticles to be added may be designed to be 5% by volume to 200% by volume based on the core particles.

When the amount of the thermoplastic resin microparticles to be added is less than 5% by volume based on the core particles, the amount of the thermoplastic resin to be stuck is too small and therefore, the probability of the core particles being exposed is increased, which leads to the tendency that it is difficult to control the adhesion of the charge control agent and the charging ability of the toner particles. Also, when the amount of the thermoplastic resin microparticles to be added exceeds 200% by volume, the volume of thermoplastic resin is in excess, and a part thereof cannot be stuck to the core particles, leading to its remaining in solution, or coagulating. In this case, even if it is intended to impart charges to the toner particles by adding a charge control agent or the like, the charge control agent or the like adheres to the free thermoplastic resin and therefore tends to hinder the charging ability of the toner particles. In a further embodiment of the invention, which addresses these problems, the amount of the thermoplastic resin microparticles to be added may be designed to be 10% by volume or more and 150% by volume or less in terms of ratio by volume to the core particles.

Also, when the amount of the charge control agent is less than 1 part by weight with respect to toner particles, the charge amount of the toner is insufficient and there is therefore a tendency that the electrodeposition film flows and the toner particles adhere to parts other than the part where the film must be formed, sometimes causing contamination. Also, when the amount exceeds 50 parts by weight, the amount of ion components in the developing agent is so excessive that the resistance of the whole developing agent is too low and there is therefore a tendency that the electrophoretic characteristics of the toner particles are deteriorated.

Examples of the core particle include fluorescent body particles and colorants such as inorganic pigments.

Examples of the fluorescent body usable in the present invention include Y₂O₃:Eu:YVO₄:Eu, (Y, Gd)BO₃:Eu, Y₂O₂S:Eu, γ-Zn₃(PO₄)₂:Mn and (ZnCd)S:Ag+InO (these compounds: red), Zn₂GeO₂:Mn, BaAl₁₂O₁₉:Mn, Zn₂SiO₄:Mn, LaPO₄:Tb, ZnS:(Cu, Al), ZnS:(Au, Cu, Al), (ZnCd)S:(Cu, Al), Zn₂SiO₄:(Mn, As), Y₃Al₅O₁₂:Ce, Gd₂O₂S:Tb, Y₃Al₅O₁₂:Tb and ZnO:Zn (these compounds: green), Sr₅(PO₄)₃CI:Eu, BaMgAl₁₄O₂₃:Eu, BaMgAl₁₆O₂₇:Eu, ZnS:Ag+red pigment and Y₂SiO₃:Ce (these compounds: blue).

Examples of the inorganic pigments usable in the present invention include natural pigments such as an ocherous pigment, chromates such as Chrome Yellow, Zinc Yellow, Barium Yellow, Chrome Orange, Molybdenum Red and Chrome Green, ferrocyan compounds such as Prussian blue, oxides such as titanium oxide, Titanium Yellow, Titanium White, Iron Oxide Red, Yellow Iron Oxide, zinc oxide, zinc ferrite, Zinc White, Iron Black, Cobalt blue, chromium oxide and Spinnel green, sulfides such as Cadmium Yellow, Cadmium Orange and Cadmium Red, sulfates such as barium sulfate, silicates such as calcium silicate and Ultramarine Blue, and metal powders such as bronze and aluminum.

The charge control agent usable in the liquid developing agent of the present invention is at least one type selected from the group consisting of metal soaps, surfactants and metal alkoxides.

Examples of the metal soaps include copper naphthanate, cobalt naphthanate, nickel naphthanate, iron naphthanate, zinc naphthanate, zirconium octylate, cobalt octylate, nickel octylate, zinc octylate, cobalt dodecylate, nickel dodecylate, zinc dodecylate, cobalt 2-ethylhexanoate, and metal sulfonates such as petroleum type metal sulfonate and metal sulfosuccinate.

Also, examples of the surfactant usable in the liquid developing agent of the present invention include sodium alkylbenzenesulfonate, calcium alkylbenzenesulfonate, sodium dioctylsulfonate, calcium dioctylsulfonate, sodium n-dodecylsulfate, sodium 1-octanesulfonate and di-2-ethylhexylsodium sulfonsuccinate.

Also, examples of the metal alkoxide usable in the liquid developing agent of the present invention include titanium tetraisopropoxide, titanium tetra-n-butoxide and tetrastearyl titanate.

According to an embodiment of the present invention, the electric insulation solvent used in the liquid developing agent of the present invention may have a boiling point in a temperature range of 70 to 250° C., a volume specific resistivity of 10⁹ Ω·cm or more, further 10¹⁰ to 10¹⁷ Ω·cm, and a dielectric constant less than 3.

As such an electric insulation solvent, for example, aliphatic hydrocarbons such as n-pentane, hexane and heptane, alicyclic hydrocarbons such as cyclopentane and cyclohexane, halogenated hydrocarbon solvents such as chlorinated alkanes, fluorinated alkanes and chlorofluorocarbon, silicon oils and mixtures of these compounds may be used. For example, a mixture of branched type paraffin solvents such as Isoper G (registered trademark), Isoper H (registered trademark), Isoper K (registered trademark), Isoper L (registered trademark), Isoper M (registered trademark) and Isoper V (registered trademark) manufactured by Exxon Corporation may be used.

Also, the thermoplastic resin microparticles used in the liquid developing agent of the present invention can be produced by a polymerization method typified by a suspension polymerization method and emulsion polymerization method.

According to an embodiment of the present invention, the thermoplastic resin microparticles may have an average particle diameter of 0.1 μm to 5 μm.

As such thermoplastic resin microparticles, for example, acryl microparticles obtained as dried powders having a primary average particle diameter of 0.1 μm to 5 μm may be used. Further, those obtained by putting acryl type resins, polyester type resins, polyamide type resins and nylon type resins not only in a microparticle form but also in a granular or pellet form or those obtained by physically milling these resins by a pulverizing machine may be used.

Also, these resins may be used after being micronized in an insulation solvent by a bead mill or ball mill such as a sand grinder. Also, any resin may be used even if it is a nonaqueous dispersion resin (NAD) obtained by dispersing an amphoteric resin having both hydrophilic part and hydrophobic part such as a block polymer and graft polymer in, for example, an insulation solvent as long as it has an average particle diameter of about 0.1 μm to 5 μm.

Examples of such a resin include a non-gel like graft polymer that has a molecular structure in which a first polymer chain constituted of a vinyl polymer soluble in the electric insulation medium solution is interconnected with a second polymer chain constituted of a vinyl polymer insoluble in the medium solution through an ester bond and that is insoluble as the whole molecule in the above medium solution and, for example, a dispersion solution of a nonaqueous type resin having a particle diameter of 0.5 μm to 1 μm, which is obtained in the following manner: for example, 100 parts of dodecylmethacrylate, 15 parts of glycidylmethacrylate and 5 parts of azobisisobutyronitrile are poured into 200 parts of isooctane heated to 90° C., the mixture is polymerized for 5 hours, then, 20 parts of CH₂═C(CH₃)COOCH₂CH₂OOCCH₂CH₂COOH and 0.0004 part of lauryldimethylamine are added to the polymerized mixture, which is then reacted at 90° C. for 5 hours, then 50 parts by weight of vinyl toluene and 1 part of benzoyl peroxide are added and then subjected to a graft reaction at 85° C. for 10 hours and then, 50 parts of AC polyethylene is added to the resulting mixture, which is then heated to 80 to 90° C. to dissolve the content, followed by rapidly cooling. Examples of such a resin also include one having the same molecular structure in which a first polymer chain and a second polymer chain are combined with each other through a urethane bond, and for example, a solution of a graft polymer having a nonvolatile component of 39.5% and a NCO content of 0.05% by weight, which is obtained in the following manner: a mixture of 96.3 g of 2-ethylhexylmethacrylate, 3.7 g of hydroxypropylmethacrylate, 2.5 g of a polymerization catalyst, Perbutyl D (trademark) (Nippon Oil & Fats Co., Ltd.) and 1.5 g of Perbutyl G (trademark) (Nippon Oil & Fats Co., Ltd.) is added dropwise to 100 g of Isoper H (Esso Standard Petroleum Co., Ltd.) for 4 hours, the mixture is stirred for 3 hours after the addition is completed, then the temperature of the system is dropped to 70° C., then, 5.7 g of isophoronediisocyanate, 0.04 g of dibutyltin dilaurate and 5.7 g of Isoper H are added to the mixture and subjected to a urethanization reaction at 70° C. for 8 hours, Isoper H is added to 80 g of the obtained solution, which is heated to 110° C. and a mixture of 2.7 g of hydroxypropylmethacrylate, 22.9 g of 2-ethylhexylmethacrylate, 34.4 g of methylmethacrylate, 0.3 g of Perbutyl D (trademark) (Nippon Oil & Fats Co., Ltd.) and 0.3 g of Perbutyl Z is added dropwise to the above solution for 2 hours, which is then reacted for 4 hours.

The liquid developing agent of the present invention has good conductivity and is highly superior in charging ability and electrophoretic ability.

When the liquid developing agent of the present invention is used, the fluorescent body layer and color filter layer of a flat type image display device can be simply formed. When the fluorescent body layer is formed, a fluorescent body may be used as the core particle. Also, when a color filter is formed, a colorant of an inorganic pigment may be used as the core particle.

A method of producing a flat type image display device according to a third invention includes a process of forming the front substrate.

This process of forming the front substrate includes:

forming a light-shielding layer having a lattice-like or stripe pattern on a transparent substrate;

supplying the liquid developing agent according to the present invention to the surface of an image support through a supply member and forming an electric field between the supply member and the image support to form a dot or stripe-like pattern image on the surface of the image support;

rolling the image support on which the pattern image has been formed along the transparent substrate which is held at a prescribed position and is provided with a light-shielding layer;

transferring to form an electric field between the rolled image support and the transparent substrate to transfer the pattern image on the surface of the image support to the transparent substrate, thereby forming a fluorescent body layer in each region on the transparent substrate partitioned by the light-shielding layer; and

forming a metal back layer on the fluorescent body layer.

In this method, the film thickness of the fluorescent body and color filter layer of the obtained display device can be controlled by controlling, for example, the composition and concentration of the liquid developing agent.

Also, in an embodiment according to the present invention, the image support may be provided with a pattern-like electrode layer that forms a pattern image on the surface thereof. The fluorescent body layer and the color filter layer can be patterned into optional shapes simply and at low cost by changing the shape of the electrode layer.

Next, referring to FIGS. 3 to 12, an example of the process of forming the front substrate used in the present invention will be explained.

FIG. 3 shows an example of a pattern formation device used in the process of forming the front substrate.

As shown in FIG. 3, this pattern formation device 10 is provided with a master plate 1 (image support) wound around a drum bare pipe (explained later) that rotates in the direction of the clock (direction of the arrow R) in the figure, a charger 2 that applies a charge to a high-resistance layer (explained later) of this master plate 1 to electrify this layer, plural developing units 3r, 3g and 3b (hereinafter generically called a developing unit 3, where it is necessary) that supply a liquid developing agent having each color (r: red, g: green and b: blue) to the master plate 1 to carry out development, a dryer 4 (drying device) that vaporizes the solvent component of the liquid developing agent stuck to the master plate 1 due to the development by air-blowing to dry the master plate 1, a stage 6 (support mechanism) that supports a glass plate 5 as a transparent substrate which is to be a transfer-receiving medium that forms a pattern of developing agent particles stuck to and transferred from the master plate 1, a coating device 7 (wetting device) that applies a high-resistance or insulation solvent to the surface of the glass plate 5 prior to the transferring operation, a cleaner 8 that cleans the master plate 1 obtained after the transfer operation is finished, and a charge removing device 9 that removes the charge of the master plate 1.

The liquid developing agent received in each color developing unit 3r, 3g or 3b is one containing charged toner particles in the insulation solvent, and these microparticles are migrated by electrophoresis in an electric field to undergo development. This toner particle contains a core particle, a silane coupling agent treatment layer disposed on the surface of the core particle, a coating layer obtained by thermoplastic resin microparticles applied to the surface of the core particle and a charge control agent added to the surface of the coating layer through the silane coupling agent treatment layer, and has a particle diameter of 1 to 10 μm. As the core particle, a structure in which pigment microparticles of each color are included inside fluorescent body particles or resin particles having an average particle diameter of about 4 (μm), or a structure in which pigment microparticles of each color are supported on the surface of resin particles is practicable.

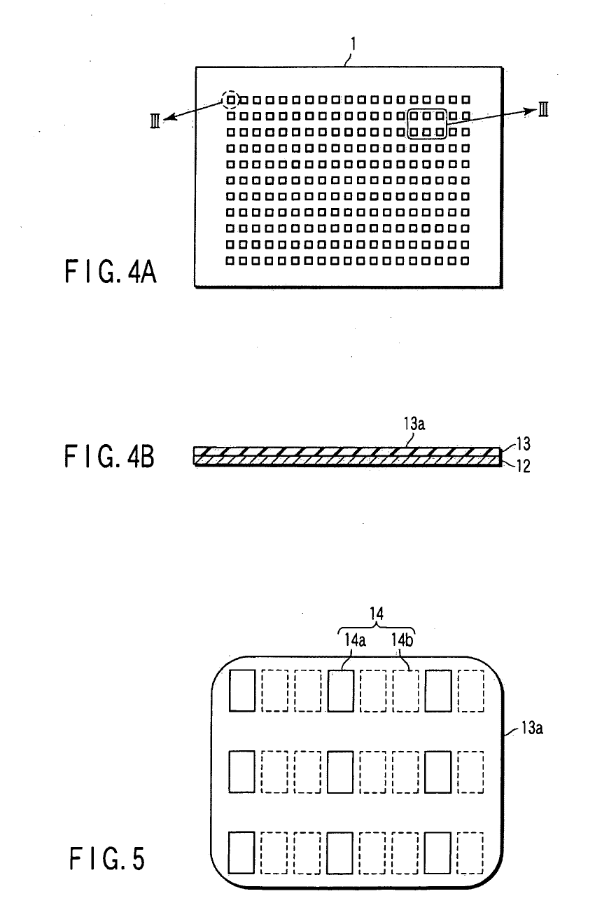

As shown by a plan view in FIG. 4A, the master plate 1 to be formed has a rectangular thin plate form. This master plate 1 according to an embodiment has a thickness of 0.05 (mm) to 0.4 (mm) as shown by a sectional view in FIG. 4B, and in a further embodiment of the present invention, the master plate 1 has a structure in which a high-resistance layer 13 is formed on the surface of a rectangular metal film 12 having a thickness of 0.1 (mm) to 2 (mm). The metal film 12 has flexibility and may be constituted of a raw material such as aluminum, stainless steel, titanium or amber or may be formed by depositing a metal on the surface of a material such as polyimide or PET. However, in order to form a transfer pattern with high positional accuracy, the metal film 12 may be constituted of a raw material resistant to elongation caused by thermal expansion or stress. Also, the high-resistance layer 13 may be formed of a material (including an insulation material) such as polyimide, acryl, polyester, urethane, epoxy, Teflon (trademark) or nylon, which has a volume resistance of 10¹⁰ (Ωcm) or more and may be formed in a thickness of, for example, 10 (μm) to 40 (μm) and further 20 (μm)±5 (μm).

Also, a dot-like pattern 14, in which a large number of rectangular concave parts 14a are arranged in line as shown by a partially enlarged view in FIG. 5, is formed on a surface 13a of the high-resistance layer 13 of the master plate 1. In this embodiment, a concave plate precursor used to produce a fluorescent screen formed on the front substrate of, for example, a flat type image display device is shown in which only a concave portion 14a corresponding to one color pixel is formed in such a manner as to form a dent in the surface 13a of the high-resistance layer 13 and no concave portion is formed but only a space is secured in the other two-color region 14b shown by the dotted line in FIG. 5.

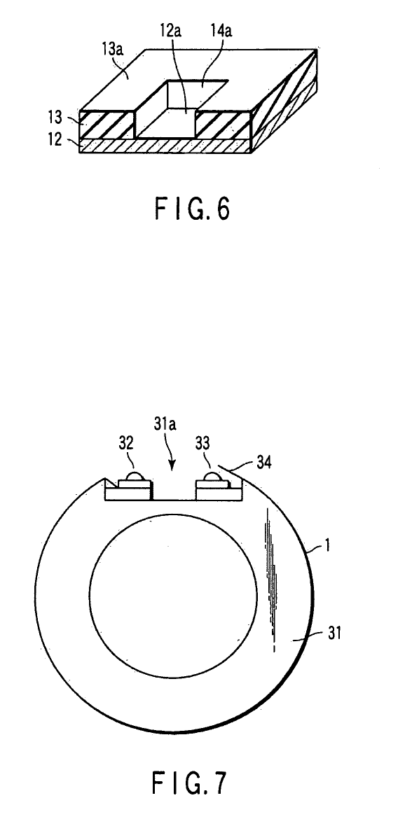

FIG. 6 shows a sectional view of the master plate 1 in which one concave portion 14a is enlarged. In this embodiment, the surface 12a of the metal film 12 is exposed from the bottom of the concave portion 14a and the exposed surface 12a of this metal film 12 functions as the pattern-like electrode layer according to this invention. The depth of the concave portion 14a is almost equal to the layer thickness of the high-resistance layer 13. If the surface 12a of the metal film 12 exposed from the bottom of the concave portion 14a and the entire surface of the master plate 1 including the surface 13a of the high-resistance layer 13 are coated with a surface releasing layer about 0.5 (μm) to 3 (μm) in thickness, the transfer characteristics are improved and better characteristics are therefore obtained.

FIG. 7 shows a schematic sectional view for illustrating the state of the film-like master plate 1 having the above structure when it is wound around a drum raw pipe 31. A clamp 32 that secures one end of the master plate 1 and a clamp 33 that secures the other end are disposed in a notch portion 31a formed on the upper part of the drum raw pipe 31 in the figure. When the master plate 1 is wound around the peripheral surface of the drum raw pipe 31, first, one end of the master plate 1 is secured to the clamp 32 and then, the master plate 1 is stretched to secure the other end 34 thereof with the clamp 33. This allows the master plate 1 to be wound, without any slack, at the predetermined position of the peripheral surface of the drum raw pipe 31.

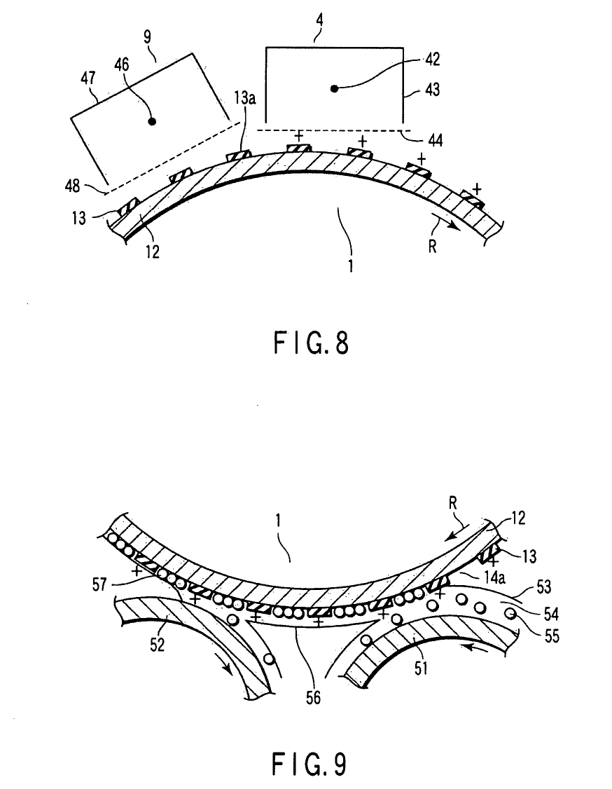

FIG. 8 is a partial structural view for explaining electrifying the surface 13a of the high-resistance layer 13 of the master plate 1 wound on the drum raw pipe 31 by using a charger 4. The charger 4 is a well-known corona charger and is basically constituted of a corona wire 42 and a sealed case 43. If a mesh-like grid 44 is provided, the uniformity of electrification can be improved. For example, when the metal film 12 and sealed case 43 of the master plate 1 are grounded and a voltage of +5.5 (kV) is applied to the corona wire 42 and a voltage of +500(V) is also applied to the grid 44 by power sources (not shown) to move the master plate 1 in the direction of the arrow R in the figure, the surface 13a of the high-resistance layer 13 is evenly charged at about +500(V).

The charge removing device 9 shown in the same figure has almost the same structure as the charger 4. When the charge removing device 9 is connected to an AC power source (not shown) to apply AC voltage at an effective voltage of 6 (kV) and a frequency of 50 (Hz) and the sealed case 47 and the grid 48 are installed, the charge of the surface 13a of the high-resistance layer 13 of the master plate 1 can be removed such that the potential of the surface 13a is almost 0(V) prior to the electrification by using the charger 4, whereby the repetitive electrification characteristics of the high-resistance layer 13 can be stabilized.

FIG. 9 shows a view for explaining a developing action on the master plate 1 charged in the above manner. When the master plate 1 is developed, the developing unit 3 of a color to be developed is made to face the master plate 1, and its developing roller 51 (supply member) and a squeeze roller 52 are made to be close to the master plate 1 to supply the foregoing liquid developing agent to the master plate 1. The developing roller 51 is disposed at a position where its periphery faces the surface 13a of the high-resistance layer 13 of the master plate 1 through a gap of about 100 to 150 (μm), and rotates at a speed of about 1.5 times to 4 times that of the master plate 1 in the same direction (counterclockwise direction in the figure) as the master plate 1.

A liquid developing agent 53 to be supplied to the peripheral surface of the developing roller 51 by a supply system (not shown) has a structure in which charged toner particles 55 as developing agent particles are dispersed in a solvent 54 as the insulating liquid, and is supplied to the peripheral surface of the master plate 1 along with the rotation of the developing roller 51. Here, when a voltage of, for example, +250(V) is applied to the developing roller 51 by a power source (not shown), the positively charged toner particles 55 migrate towards the metal film 12 having a ground potential in the solvent 54 and are collected in the concave portion 14a of the master plate 1. Because, at this time, the surface 13a of the high-resistance layer 13 is charged to about +500(V), the positively charged toner particles 55 are repelled by the surface 13a and are therefore not stuck to the surface 13a.

After the toner particles 55 are collected in the concave portion 14a of the master plate 1 in this manner, the liquid developing agent 53 decreased in the concentration of the toner particles 55 then penetrates into the gap where the squeeze roller 52 and the master plate 1 face each other. Here, the system is so designed that the length of the gap (distance between the surface 13a of the insulation layer 13 and the surface of the squeeze roller 52) is 30 (μm) to 50 (μm), the potential of the squeeze roller is +250(V) and the squeeze roller 52 travels at a speed of about 3 times to 5 times that of the master plate 1 in the opposite direction as the master plate 1, and therefore produces the effect of further promoting the development and at the same time, squeezing a part of the solvent 56 stuck to the master plate 1. A pattern 57 is thus formed in the concave portion 14a of the master plate 1.

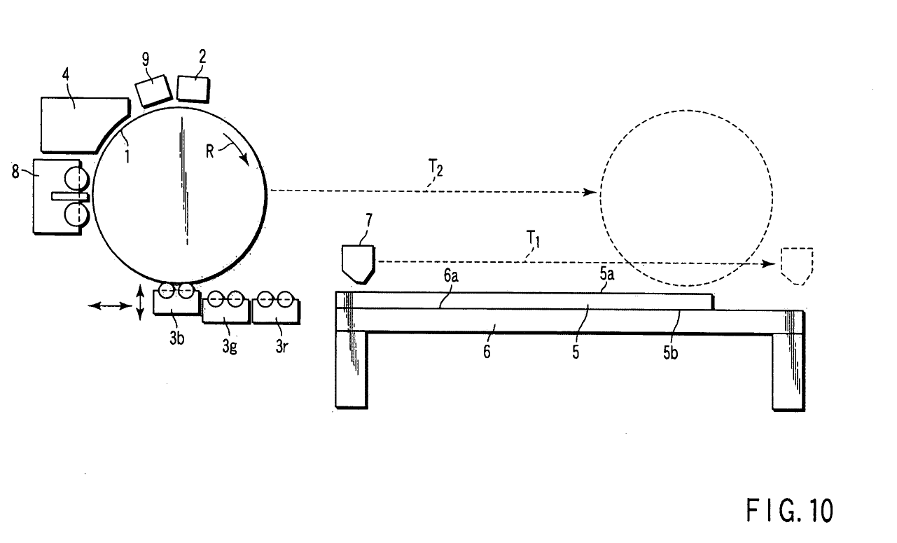

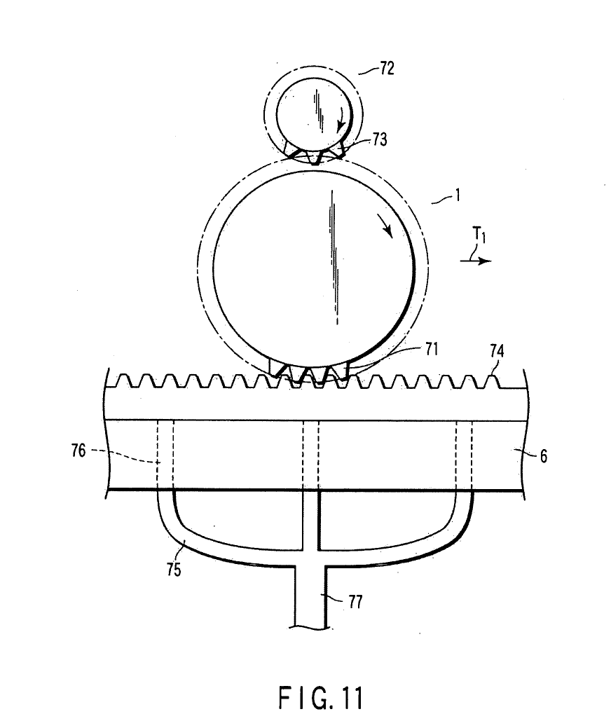

In the meantime, when a three-color fluorescent body pattern is formed on the glass plate 5, first, the developing unit 3b that receives the liquid developing agent containing blue fluorescent body particles travels to a position just under the master plate 1 as shown in FIG. 10, where the developing unit 3b is made to rise by an elevation mechanism (not shown) to be close to the master plate 1. In this state, the master plate 1 rotates in the direction of the arrow R to develop the pattern of the concave portion 14a. When the development of the blue pattern is finished, the developing unit 3b goes down and is separated from the master platemaster plate 1.

During the course of this blue color developing process, the coating device 7 travels in the direction of the dotted arrow T1 in the figure along the surface of the glass plate 5 which surface is apart from the stage 6, the glass plate 5 being carried on the stage 6 and being conveyed in advance by a conveyer (not shown) to apply the solvent (insulation liquid) to the surface of the glass plate 5. The role and material composition of this solvent will be explained later.

Thereafter, the master platemaster plate 1 carrying a blue pattern on its peripheral surface travels along the dotted arrow in the figure while rotating (this action is called rolling) to transfer a blue pattern image to the surface of the glass plate 5. The details of the transfer will also be explained later. The master platemaster plate 1 that finishes the transfer of a blue pattern is translated in parallel to the left side in the figure and returns to the start position where the development is carried out. At this time, the stage 6 carrying the glass plate 5 descends to avoid contact with the master platemaster plate 1 returning to the start position.

Next, the three color developing units 3r, 3g and 3b travel to the left side in the figure and the green developing unit 3g stops at the position just under the master platemaster plate 1 and then, the raising, development and descending of the developing unit 3g are carried out in the same manner as in the case of developing the blue color. In succession, a green pattern is transferred to the surface of the glass plate 5 from the master platemaster plate 1 in the same operation as above. It is needless to say that, at this time, the position on the surface of the glass plate 5 where the green pattern is transferred to is shifted by a distance corresponding to one color part from the foregoing blue pattern.

Then, the above action is repeated in the case of red color development to transfer a three-color pattern in line on the surface of the glass plate 5, thereby forming a three-color pattern image on the surface of the glass plate 5. The glass plate 5 is kept at a fixed position and secured and the master platemaster plate 1 is made to travel with respect to the glass plate 5 in this manner, which makes it unnecessary to move the glass plate 5 back and forth, whereby the securement of a large movable space and the development of a large-scale device can be restricted.

FIG. 11 shows the structure of the essential part of the rolling mechanism for rolling the aforementioned master platemaster plate 1 along the glass plate 5. A pinion gear 71 is fitted to the both ends in the axial direction of the drum raw pipe 31 provided with the master platemaster plate 1 wound around its peripheral surface. The master plate 1 is rotated by the engagement of the gear 71 with a drive gear 73 of a motor 72 and also, forwarded in the right direction in the figure by the engagement of a linearly tracked rack 74 disposed on both sides of the stage 6 with the pinion (gear 71). The structure of each part of the rolling mechanism is designed in order to prevent relative slippage between the surface of the glass plate 5 and the surface of the master plate 1 which are held on the stage 6. In the claims, the action of the master plate 1 that travels in parallel along the glass plate 5 while rotating in this manner is called rolling.

Such a rack and pinion mechanism ensures that highly precise rotating and translating driving can be attained without backlash due to lack of an idler for drive transmission, and a highly precise pattern with positional accuracy as high as, for example, ±5 (μm) can be transferred to the surface of the glass plate 5.

On the other hand, the glass plate 5 (not illustrated in FIG. 11) is disposed on the stage 6 in such a manner that an almost entire backside surface 5b (surface on the side apart from the master plate 1) is in contact with a flat contact surface 6a of the stage 6 as shown in FIG. 10. In addition, a negative pressure is made to act on the glass plate 5 through an adsorbing hole which is, though not shown, opened on the contact surface 6a of an intake port 76 by connecting a vacuum pump, which is not shown, from a connecting pipe 75 through a main pipe 77 with the intake port 76 which penetrates through the stage 6 and extends to the contact surface 6a, whereby the glass plate 5 is stuck to the contact surface 6a of the stage 6. With this adsorbing mechanism, the glass plate 5 is tightly stuck to the contact surface 6a having high flatness in such a manner that almost the entire backside surface 5b is pressed against the contact surface 6a and supported on the stage 6 in a highly planar state. Even the strain or the like of the glass plate 5 can be corrected and the transfer gap between the glass plate 5 and the master plate 1, which will be explained later, can be maintained with high accuracy by pressing the glass plate 5 to the flat contact surface 6a in this manner.

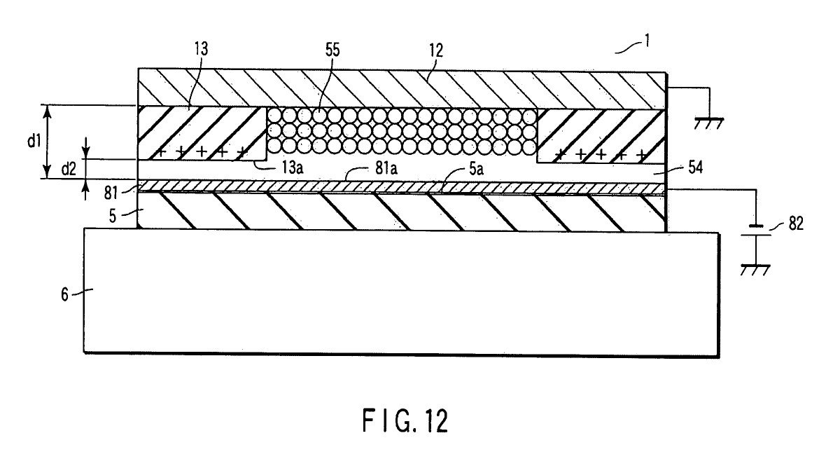

FIG. 12 is a sectional view of an essential part for explaining the situation where the toner particles 55 are transferred from the master plate 1 to the glass plate 5. A conductive layer 81 constituted of, for example, a conductive polymer is applied to the surface 5a of the glass plate 5 having a light-shielding layer (not shown). A surface 81a of the conductive layer 81 and the surface 13a of the high-resistance layer 13 of the master plate 1 are disposed in a non-contact state through a gap d2. The above gap d2 is set to, for example, a value range of 10 (μm) to 40 (μm). When the thickness of the high-resistance layer 13 is, for example, 20 (μm), the distance between the metal film 12 and the surface 81a of the conductive layer 81 is 30 (μm) to 60 (μm).

When, in this state, for example, a voltage of −500(V) is applied to the conductive layer 81 through a power source 82 (transfer device), a potential difference of 500(V) is formed between the conductive layer 81 and the metal film 12 having the ground potential and the formed electric field allows the toner particles 55 to electrophoretically migrate within the solvent 54 and be transferred to the surface 81a of the conductive layer 81. Because the toner particles 55 can be transferred even in such a non-contact state, it is unnecessary to interpose an elastic body such as a blanket or flexographic plate, unlike offset-printing or flexo-printing, and it is therefore possible to always attain transfer with high positional accuracy. The conductive layer 81 is eliminated by putting the glass plate 5 in a baking furnace, though not shown, to bake it after the toner particles 55 are transferred. A front substrate of the display device according to the present invention is obtained in this manner.

In the case of transferring the toner particles to the glass plate 5 by using an electric field in the above manner, it is essential that a solvent be present in the transfer gap to wet the space between the conductive layer 81 on the glass plate 5 side and the master plate 1. Therefore, it is effective to pre-wet the surface 5a of the glass plate 5 with a solvent prior to the transfer operation. Although any solvent may be used as the pre-wetting solvent as long as it has insulating ability and high resistance, it may be useful to use the same solvent as that used in the liquid developing agent or the same solvent to which a charge control agent and the like are added. The pre-wetting solvent is applied to the surface 5a of the glass plate 5 by using the coating device 7 at an adequate timing and in a proper amount as has been explained with reference to FIG. 10.

According to the aforementioned embodiment, the master plate 1 is made to roll with respect to the glass plate 5 disposed on a fixed position to transfer the developed toner particles 55 to the surface 5a of the glass plate 5. Therefore, the structure of the rolling mechanism that rolls the master plate 1 can be downsized, to thereby decrease the space necessary to install the device. Also, according to the above embodiment, the toner particles 55 are transferred using an electric field from the master plate 1 to the glass plate 5 which are disposed opposite to each other in a non-contact state. Therefore, the resolution of the transferred image can be improved, whereby a more highly accurate pattern can be formed as compared with a conventional transfer system using a flexographic plate.

Also, in the foregoing embodiment, the (developed) toner particles 55 collected in the concave portion 14a of the master plate 1 are dried once by air blowing from the dryer 4 and then, the surface 5a of the glass plate 5 is wetted (pre-wetted) with a solvent to transfer the toner particles 55. Therefore, the shape of the toner image transferred to the surface 5a of the glass plate 5 can be stabilized and therefore, the contour of the pattern can be made distinctive.

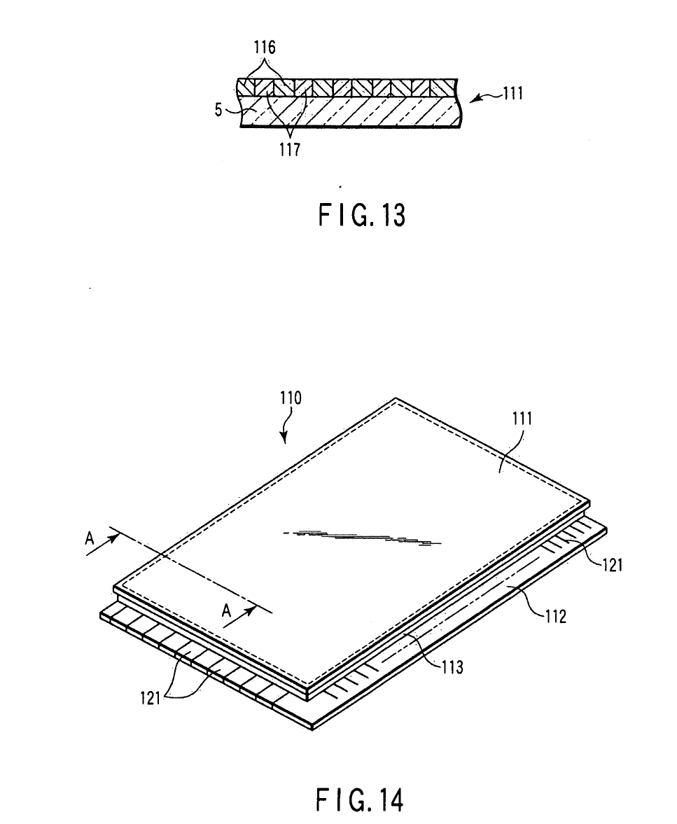

FIG. 13 is a sectional view typically showing the front substrate obtained in this manner.

As shown in FIG. 13, an obtained front substrate 111 is provided with a transparent substrate 5, a fluorescent body layer 116 formed dot-wise on the transparent substrate 5 and a light-shielding layer 117 formed lattice-wise around the fluorescent body layer 116.

FIG. 14 is a perspective view showing an example of an FED as the display device according to the present invention.

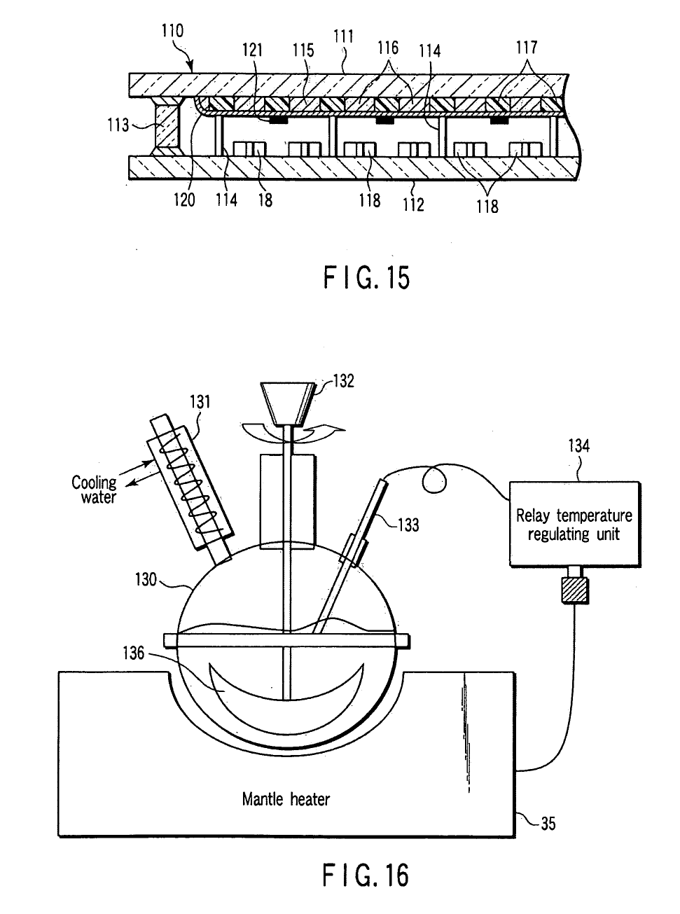

Also, FIG. 15 shows a sectional view along the line A-A′ in FIG. 14.

As shown in FIGS. 14 and 15, this FED is provided with the front substrate 111 and a backface substrate 112 which are made of rectangular glass plates as insulating substrates, and these substrates are disposed opposite to each other through a clearance of 1 to 2 mm. Then, the periphery of the front substrate 111 and the periphery of the backface substrate 112 are joined with each other via a side wall 113 having a rectangular frame shape to constitute a vacuum envelope 110 having a flat and rectangular form, the inside of which is kept under vacuum.

In the vacuum envelope 110, plural spacers 114 are disposed to withstand an atmospheric load applied to the front substrate 111 and backface substrate 112. As the spacer 114, a plate or column type spacer or the like may be used.

A fluorescent plane 115 provided with red, green and blue fluorescent body layers 116 and a matrix-like light-shielding layer 117 is formed as an image display plane on the inside surface of the front substrate 111. These fluorescent body layers 116 may be formed stripe-wise or dot-wise. A metal back 120 made of an aluminum film or the like is formed on this fluorescent plane 115. Further, a getter film 121 is formed to adsorb unnecessary gas in the vacuum envelope 110, thereby reducing the internal pressure of the vacuum envelope. A material having an adhesive effect is mixed in a getter powder to stick the getter film.

Many surface conductive type electron emitting elements 118, each emitting an electron beam, are provided on the inside surface of the backside substrate 112 as electron sources for exciting the fluorescent body layer 116 of the fluorescent plane 115. These electron emitting elements 118 are arranged in plural rows and in plural lines corresponding to each pixel. Each electron emitting element 118 is constituted of, for example, an electron emitting section, which is not shown, and a pair of elemental electrodes that apply a voltage across the electron emitting section. Also, a large number of wires 121 that supply a potential to the electron emitting elements 118 are formed matrix-wise in the inside surface of the backside substrate 112 and each terminal of these wires is drawn out of the vacuum envelope 110.

When an image is displayed in such an FED, an anode voltage is applied across the fluorescent plane 115 and the metal back 120 and an electron beam emitted from the electron emitting element 118 is accelerated by the anode voltage to allow the electron beam to collide with the fluorescent plane. The fluorescent body layer 116 of the fluorescent plane 115 is excited to emit light, thereby displaying a color image.

Next, a fourth invention according to the present invention will be explained.

The liquid developing agent of the present invention contains an electric insulation solvent and toner particles each including a core particle, a coating layer made of thermoplastic resin microparticles and formed on the core particle, and a charge control agent added to the coating layer, wherein the charge control agent to be used is an organic compound containing at least one type of lanthanoid metal.

Here, the coating layer is designed to cover at least a part of the surface of the toner particle.

The liquid developing agent of the present invention uses an organic metal compound containing at least one type of lanthanoid metal as the charge control agent, whereby the influence of the uneven state of the surface of the core particle coated with a resin can be limited in providing charges to toner particles. This is considered to be because the lanthanoid metal has a high charge providing ability due to the adsorption and coordination of the lanthanoid metal to the surface of the core particle and also because the adsorption and the equilibrium of coordination is rapid, and thus the charged state is kept in a stable state.

In the case where the surface of the core particle is coated with, for example, a resin, the charge control agent is charged when it is adsorbed to the surface of the resin coating layer or coordinates as an acid or base with a functional group on the surface of the resin coating layer. Here, the adsorbing site and coordinating site of the surface of the core particle coated with a resin are not always put into a uniform surface state. The molecular weight of the resin, nonuniform distribution of functional groups and steric hindrance cause a nonuniform surface state of the adsorption site and coordination site. If the charge providing ability is small when the particles are put in such a nonuniform condition, the influence of the surface condition is large and therefore, the charging ability of the surface of the particle is nonuniform. Moreover, if the equilibrium of adsorption and coordination is slow, the charged state becomes unstable, which increases a variation in charging ability with time or a variation in charging ability depending on working environment. As a result, it is difficult to control the electrophoretic ability and to carry out electrodeposition for forming a highly precise toner layer. On the other hand, when an organic metal compound containing at least one type of lanthanoid metal is used as the charge control agent, it is superior in charge providing ability and therefore, the charging ability of individual particles is not adversely affected by such a nonuniform surface condition of the core particle coated with a resin but is more improved, making it possible to retain a stable charging ability over a long period of time. Also, the variation in charging ability due to variation in working environment is decreased. As a result, the electrophoretic ability is well controlled and a highly precise toner layer can be formed by electrodeposition. Also, the uniformization of the charging ability of individual particles improves the dispersibility of the toner particles caused by electric repulsion in the toner solution.

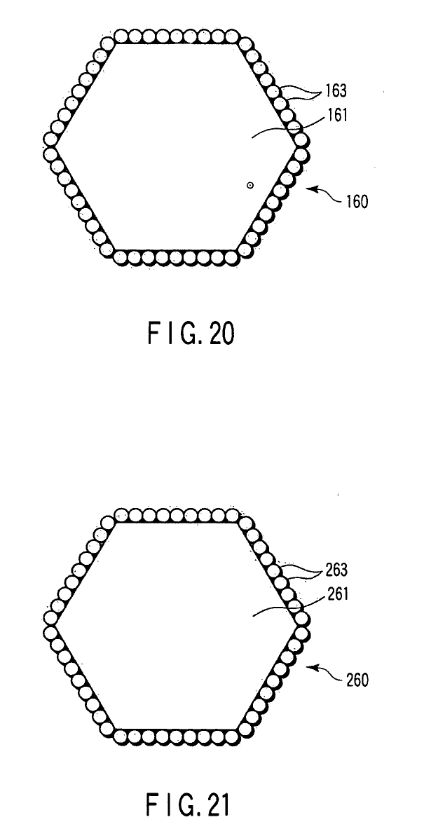

FIG. 20 shows a model view for explaining an example of the structure of the toner particles contained in the liquid developing agent of the present invention.

As is illustrated, this toner particle 160 includes a core particle 161, a coating layer of thermoplastic resin microparticles 163 applied to the surface of the core particle 161 and a charge control agent, though not shown, which is present on the surface of the coating layer of thermoplastic resin microparticles 163.

The core particle may have an average particle diameter of 0.01 to 10 μm. When the average particle diameter is less than 0.01 μm, intermolecular coagulation of the core particle is increased, leading to a tendency that uniform dispersion is difficult. When a material having such a small average particle diameter and deteriorated in dispersibility, for example, pigment microparticles having an average particle diameter of several nm are used, the dispersibility is improved and therefore, these pigment particles can be applied if they are carried on a core particle made of a resin and have a larger average particle diameter. Also, when the average particle diameter exceeds 10 μm, it tends to be difficult to stir the core particles uniformly, with the result that it is difficult to form a uniform resin layer.

In an embodiment of the present invention, the ratio by weight of the toner particles to the insulation solvent may be designed to be 2:98 to 50:50.

When the ratio by weight of the toner particles is less than the above range, a large amount of solvent is required to obtain a toner layer having a prescribed film thickness. Also, when the ratio by weight of the toner particles exceeds the above range, there is a tendency that the toner particles adhere to parts other than the part where the toner layer is to be formed, causing contamination.

In an embodiment of the invention, the liquid developing agent according to the fourth invention may contain, as the charge control agent, an organic metal compound having a metal content corresponding to 0.001 to 10% by weight based on the weight of the core particle.

When the metal content of the charge control agent is less than 0.001% by weight based on the core particle, there is a tendency that the toner particles are insufficiently charged. The insufficiently charged toner particles are controlled in an electric field with difficulty and there is therefore a tendency that if such toner particles are increased, this causes the flow of the electrodeposition film, and the toner particles adhere to parts other than the part where the toner layer is to be formed, causing contamination.

Also, when the metal content of the charge control agent exceeds 10% by weight based on the core particle, the amount of ionic components in the liquid developing agent is excessive, so that the resistance of the whole liquid developing agent is lowered too much, leading to a tendency that the electrophoretic ability of the toner particles is deteriorated.

In a further embodiment of the invention, which takes these problems into account, these charge control agents may be added in an amount of 0.01% by weight to 10% by weight based on the weight of the core particle.

According to an embodiment of the invention, the amount of the thermoplastic resin microparticles to be added may be 1.0 to 20% by weight based on the weight of the core particle.

When the amount of the thermoplastic resin microparticles to be added is less than 1% by weight based on the core particle, the ratio of the core particles being exposed is raised too much, and the surface state of the core particles becomes nonuniform, and there is therefore a tendency that the distribution of the charge control agent is nonuniform and it is difficult to control the charging ability of the toner particles. Also, when the amount of the thermoplastic resin microparticles to be added exceeds 20% by weight, the amount of the thermoplastic resin microparticles needed for the core particle is in excess, such that thermoplastic resin microparticles which cannot stick or adsorb to the surface of the core particle tend to increase. In this case, the charge control agent added in the liquid developing agent also adsorbs to the free thermoplastic resin microparticles to thereby tend to hinder the charging ability of the toner particles. In a further embodiment of the invention, which takes these problems into account, the amount of the thermoplastic resin microparticles to be added may be designed to be 3% by weight or more and 10% by weight or less based on the core particles.

Examples of the core particle include fluorescent body particles, pigment particles and colored resins containing colorants.

As the fluorescent body usable in the present invention, the same fluorescent bodies used in the first to third inventions may be used.

Specific examples of the inorganic pigments include natural pigments such as an ocherous pigment, chromates such as Chrome Yellow, Zinc Yellow, Barium Yellow, Chrome Orange, Molybdenum Red and Chrome Green, ferrocyan compounds such as Prussian blue, oxides such as titanium oxide, Titanium Yellow, Titanium White, Iron Oxide Red, Yellow Iron Oxide, zinc oxide, zinc ferrite, Chinese White, Iron Black, Cobalt blue, chromium oxide and Spinel Green, sulfides such as Cadmium Yellow, Cadmium Orange and Cadmium red, sulfates such as barium sulfate, silicates such as calcium silicate and Ultramarine Blue, metal powders such as bronze and aluminum, and carbon black.

Specific examples of the organic pigment include natural lakes such as a Madder lake; nitron type pigments such as naphthol green and naphthol orange; soluble azo types such as benzidine yellow G, Hansa Yellow G, Hansa Yellow 10G, Vulcan Orange, Lake Red R, Lake Red C, Lake Red D, Watching Red, Brilliant Carmine 6B, Pyrazolone Orange, Bordeaux 10G, and (Formaroon); azo type pigments, for example, insoluble azo types such as Pyrazolone Red, Para Red, Toluidine Red, ITR Red, Toluidine Red (Lake Red 4R), Toluidine Maroon, Brilliant Fast Scarlet and Lake Bordeaux 5B and condensed azo types; condensed polycyclic type pigments, for example, phthalocyanine type pigments such as Phthalocyanine Blue, Phthalocyanine Green, Brominated Phthalocyanine Green and Fast Sky Blue, anthraquinone types such as Styrene Blue, perylene types such as Perylene Maroon, perinone types such as Perino Orange, quinacridone types such as quinacridone and dimethylquinacridone, dioxazine types such as Dioxazine Violet, isoindoline types and quinophthalone types; mordant dye type pigments, for example, basic dye lakes such as Rhodamine 6B, Lake, Rhodamine Lake B and Malachite Green and Alizarin Lake; vat dye type pigments such as Indanthrene Blue, Indigo Blue and Anthanthrone Orange; fluorescent pigments; azine pigments (Diamond Black); and Green Gold.

Examples of the resin materials for the resin particles used in the colored resin particles containing colorants may include homopolymers or copolymers of vinyl type monomers, for example, styrenes such as styrene, o-methylstyrene, m-methylstyrene, p-methylstyrene, p-methoxystyrene, p-phenylstyrene, p-chlorostyrene, 3,4-dichlorostyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene and p-n-dodecylstyrene and their derivatives; unsaturated monoolefins such as ethylene, propylene and isobutylene; vinyl halides such as vinyl chloride, vinylidene chloride and vinyl fluoride; vinyl esters such as vinyl acetate, vinyl propionate and vinyl benzoate; α-methylene aliphatic monocarboxylates such as methylmethacrylate, ethylmethacrylate, propylmethacrylate, n-butylmethacrylate, isobutylmethacrylate, n-octylmethacrylate, dodecylmethacrylate, 2-ethylhexylmethacrylate, stearylmethacrylate, phenylmethacrylate, dimethylaminoethylmethacrylate and diethylaminoethylmethacrylate; acrylates such as methylacrylate, ethylacrylate, n-butylacrylate, isobutylacrylate, propylacrylate, n-octylacrylate, dodecylacrylate, 2-ethylhexylacrylate, stearylacrylate, 2-chloroethylacrylate and phenylacrylate; vinyl ethers such as vinyl methyl ether, vinyl ethyl ether and vinyl isobutyl ether; vinyl ketones such as vinyl methyl ketone, vinylhexyl ketone and methyl isopropenyl ketone; N-vinyl compounds such as N-vinyl pyrrole, n-vinyl carbazole, N-vinyl indole and N-vinyl pyrrolidone; vinyl naphthalic acid; and acrylic acid and methacrylic acid derivatives such as acrylonitrile, methacrylonitrile and acrylamide. Typical examples of the binder resin may include polystyrene, styrene/acrylic acid copolymers, styrene/methacrylic acid copolymers, styrene/acrylonitrile copolymers, styrene/butadiene copolymers, polyester, polyurethane, epoxy resins, silicon resins and polyamide.

The charge control agent used in the fourth invention is an organic compound containing at least one type of lanthanoid metal. Examples of the lanthanoid metal include La, Ce, Eu, Gd and Tb. Examples of those combined with these metals to constitute the organic metal compounds include metal salts of organic acids such as metal naphthenates, metal octylates, metal laurates, metal oleates, metal secanoates and metal dodecylates, chelate complex compounds such as acetyl acetone metal salts, and metal alkoxides.

The electric insulation solvent to be used in the liquid developing agent of the fourth invention is the same as that used in the first to third inventions and may have a boiling point ranging from 70 to 250° C., a volume specific resistance of 10⁹ Ω·cm or more and 10¹⁰ Ω·cm to 10¹⁷ Ω·cm and a dielectric constant less than 3.

Also, the thermoplastic resin microparticles may be produced using a polymerization method typified by, for example, a suspension polymerization method or an emulsion polymerization method.

According to an embodiment of the present invention, the average particle diameter of the thermoplastic resin microparticles may be 0.1 to 5 μm.

When the average particle diameter of the thermoplastic resin is less than 0.1 μm, the distribution of composition in its synthesis tends to be nonuniform and a resin component which neither sticks nor adsorbs to the core particle increases, with the result that a floating residual resin is charged by the charge control agent, causing nonuniform toner composition and making it difficult to form a highly precise pattern. Also, when the average particle diameter exceeds 5 μm, the principal chain of the resin is largely entangled and the spreading of the principal chain in the solvent is deteriorated, easily resulting in nonuniform sticking and adsorption of the resin particles to the surface of the core particle.

As the thermoplastic resin microparticles, acryl type microparticles obtained as a dry powder having a primary average particle diameter of about 0.1 μm to 5 μm may be utilized. Also, a material to be used as the thermoplastic resin microparticles need not be put into a form of microparticles, and an acryl type resin, polyester type resin, polyamide type resin, nylon type resin or other thermoplastic resin which is in a granular or pellet form or those obtained by physically milling these resins by a pulverizer or the like may be used instead.

Also, these thermoplastic resins may be used after they are micronized in the insulation solvent by a bead mill such as sand grinder or ball mill.

In order to dispose the thermoplastic resin microparticles on the core particle, for example, a method may be exemplified in which a dispersion system containing the core particle and the thermoplastic resin microparticles is stirred under heating at a temperature higher than the softening point of the thermoplastic resin microparticles. However, when a hydrophilic fluorescent body is used as the core particle, thermoplastic resin microparticles may not stick even if those having hydrophobic characteristics are applied as the thermoplastic resin particles. In such a case, the core particle is surface-treated with a silane coupling agent in advance such that the layer treated with the silane coupling agent functions as a binder to make the core particle compatible with the thermoplastic resin microparticles, to thereby stick the thermoplastic resin microparticles to the surface of the core particle, or a wax or the like is made to precipitate together with the thermoplastic resin microparticles on the core particle, whereby the thermoplastic resin microparticles can be stuck to the surface of the core particle.

The concentration of the silane coupling agent aqueous solution used to carry out uniform surface treatment on the core particle, water-alcohol solution or aqueous acetic acid solution is adjusted to about pH 4 may be 0.01% by weight to 5% by weight.

When the concentration of the silane coupling agent is less than 0.01% by weight, the surface of the core particle is not treated sufficiently by the silane coupling treatment and there is therefore a tendency that the thermoplastic resin microparticles are insufficiently stuck to the core particle, whereas when the concentration of the silane coupling agent exceeds 5% by weight, there is a tendency that an uneven silane coupling treatment is carried out. Further, any excess amount of the silane coupling agent that cannot be dissolved by the solvent may coagulate.

Using the liquid developing agent according to the fourth invention, a fluorescent plane of an image display device and further, a front substrate including this fluorescent plane can be formed in the same manner as in the first to third inventions.

In this method, the film thickness of the fluorescent body layer of the obtained display device can be controlled by regulating, for example, the composition and concentration of the liquid developing agent.

In the following, the liquid developing agent according to a fifth invention is used. The liquid developing agent of the present invention contains an electric insulation solvent and toner particles, wherein the toner particle contains a core particle, a coating layer of thermoplastic resin microparticles formed on the core particle and a charge control agent added to the surface of the coating layer, and the core particle made of a ZnS type fluorescent body is used.

The charge control agent used in the fifth invention contains at least one metal compound containing at least one of the IIA Group and IIIA group metals.

The fifth invention ensures that since at least one metal compound containing the IIA group or IIIA group metal is applied as the charge control agent, the charge control agent imparts sufficient charging ability to the toner particles and is also uniformly distributed and left on the surface of the particle after electrodeposition, to thereby obtain the effect of suppressing a deterioration in luminance caused by heat treatment in the process of forming the fluorescent plane and a deterioration in luminance (emission life) in the course of emission display using electron rays or the like. This is considered to be because a deterioration in luminance caused by the generation of lattice defects on the surface of a ZnS mother body is limited by these IIA group or IIIA group metals.

FIG. 21 is a typical sectional view showing the structure of the toner particles in the liquid developing agent according to the fifth invention.

As is illustrated, this toner particle 260 is formed with a core particle 261 made of a ZnS type fluorescent body and a coating layer made of resin microparticles 263 stuck to the core particle 261.

Here, the coating layer is designed to cover at least a part of the surface of the toner particle.

A charge control agent, though not shown, is added to the surface of the toner particle.

The charge control agent added to the surface of the toner particle may be adsorbed to the surface or may be coordinated as an acid or base with functional groups on the surface.

Also, in the liquid developing agent, materials which are added to the coating layer of the thermoplastic resin microparticles and adsorbed or coordinated are at least a part of the charge control agent and its organic compound present in the electric insulation solvent. The remainder part of the charge control agent and its organic compound does not act on the surface of the coating layer of the thermoplastic resin microparticles but can be present in the electric insulation solvent.

In an embodiment of this invention, the core particle may have an average particle diameter of 1 to 10 μm. When the average particle diameter is less than 1 μm, intermolecular coagulation of the core particle is increased and there is a tendency that uniform dispersion of the core particle will not take place. When the average particle diameter exceeds 10 μm, it is difficult to stir the core particle uniformly, with the result that it is difficult to form a uniform resin layer, and also, the distribution of the charge control agent present on the surface of the resin layer is nonuniform, causing a bias in the charge of individual particles

making it difficult to control these particles in an electric field. Also, since the distribution of the charge control agent is nonuniform, a deterioration in luminance caused by heat treatment in the process of forming the film and a deterioration in luminance (emission life) in the course of emission display using electron rays or the like tend to progress.

In an embodiment of the present invention, the ratio by weight of the toner particles to the insulation solvent may be designed to be 2:98 to 50:50 based on 100 parts by weight of the liquid developing agent.

If the ratio by weight of the toner particles is out of the above range, a large amount of solvent is required to obtain a toner layer having a prescribed film thickness. Also, there is a tendency that the toner particles adhere to parts other than the part where the toner layer is to be formed, causing contamination.

According to an embodiment of the present invention, the charge control agent may contain a metal corresponding to 0.001 to 10% by weight based on the weight of the core particle.

When the charge control agent is less than 0.001% by weight based on the toner particle, there is a tendency that the toner particles are insufficiently charged, so that many particles cannot be controlled by an electric field, which causes the electrodeposition film to flow, and the toner particles adhere to parts other than the part where the toner layer is to be formed, causing contamination. Also, the content of the IIA group or IIIA group metal remaining on the surface of the core particle is too small and the effect of suppressing a deterioration in luminance is obtained only insufficiently.

Also, when the content of the charge control agent exceeds 10% by weight, the amount of ionic components in the liquid developing agent is excessive, so that the resistance of the liquid developing agent as a whole is lowered too much, and therefore the electrophoretic ability of the toner particles tends to be deteriorated.

In a further embodiment of the invention, which takes these problems into account, these charge control agents may be added in an amount of 0.01% by weight or more to 2% by weight or less based on the weight of the core particle.

According to an embodiment of the present invention, the content of the thermoplastic resin microparticles may correspond to 1.0 to 20% by weight based on the weight of the core particle.

When the content of the thermoplastic resin microparticles is less than 1% by weight based on the core particle, for example, core particles to which no resin is stuck may be present, which therefore increases the probability that the core particles are exposed, because the amount of resin adhered to or adsorbed to the core particle is too small. There is therefore a tendency that the surface state of the core particles is nonuniform and hence, the distribution of the charge control agent is nonuniform and it is thus difficult to control the charging ability of the toner particles. Also, because the distribution of the IIA group and IIIA group metals remaining after electrodeposition is nonuniform, a deterioration in luminance caused by heat treatment in the process of forming the film and a deterioration in luminance (emission life) in the course of emission display using electron rays or the like tend to progress.

Also, when the content of the thermoplastic resin microparticles exceeds 20% by weight, the amount of resin to stick or adsorb to the core particle is superfluous, thus the resin remains in solution. In this case, even if it is intended to add a charge control agent to thereby impart charges to the toner particles, the charge control agent is also stuck to the free resin, which hinders the development of the charging characteristics of the toner particles. In a further embodiment of the invention, which takes these problems into account, these thermoplastic resins may be added in an amount of 3% by weight or more to 10% by weight or less based on the weight of the core particle.

Examples of the core particle used in the fifth invention include fluorescent body particles using ZnS as its mother body.

Examples of the fluorescent body using ZnS as its mother body include blue emission fluorescent bodies such as ZnS:Ag, Cl, ZnS:Ag, Cl, Al, (Zn, Cd)S:Ag, (Zn, Cd)S:Ag, Cl, (Zn, Cd)S:Ag, Green emission fluorescent bodies such as ZnS:Cu, Al, ZnS:Cu, ZnS:Cu, Al, Au, (Zn, Cd)S:Cu, Al, (Zn, Cd)S:Cu and (Zn, Cd)S:Cu, Al and Au and red emission fluorescent bodies such as (Zn, Cd)S:Ag+InO.

As the charge control agent used in the fifth invention, a compound containing at least one of the IIA group or IIIA group metals may be used. Examples of such a compound include organic compounds, for example, metal organic acid salts having 6 to 30 carbons such as organic acid salts such as naphthenates, octylates, laurates, oleates, secanoates and dodecylates, chelate complex compounds and metal alkoxides. Also, inorganic compounds such as phosphates and nitrates may also be used.

As the electric insulation solvent used in the liquid developing agent, the same solvent used in the first to fourth inventions may be used.

Also, the thermoplastic resin microparticles used in the present invention may be produced using a polymerization method typified by a suspension polymerization method and emulsion polymerization method.

According to an embodiment of the present invention, the thermoplastic resin microparticles may have an average particle diameter of 0.1 μm to 5 μm.

When the average particle diameter of the thermoplastic resin microparticles is less than 0.1 μm, the distribution of composition in its synthesis tends to be nonuniform and a resin component which neither sticks nor adsorbs to the core particle increases, with the result that a floating residual resin is charged by the charge control agent, causing a nonuniform toner composition and making it difficult to form a highly precise pattern.

Also, when the average particle diameter exceeds 5 μm, the principal chain of the resin is largely entangled and the spreading of the principal chain in the solvent is deteriorated, easily resulting in nonuniform sticking and adsorption of the resin particles to the surface of the core particle.

As the thermoplastic resin microparticles, acryl type microparticles obtained as a dry powder having a primary average particle diameter of about 0.1 μm to 5 μm may be utilized. Also, a material to be used as the thermoplastic resin microparticles may not be put into a form of microparticles, and an acryl type resin, polyester type resin, polyamide type resin or nylon type resin which is put into a granular or pellet form or those obtained by physically milling these resins by a pulverizer or the like may be used.

Also, these thermoplastic resins may be used after they are micronized in the insulation solvent by a bead mill such as sand grinder or ball mill.

In order to dispose the thermoplastic resin microparticles on the core particle, for example, a method may be exemplified in which a dispersion system containing the core particle and the thermoplastic resin microparticles is stirred under heating at a temperature higher than the softening point of the thermoplastic resin microparticles. However, when a hydrophilic fluorescent body is used as the core particle, thermoplastic resin microparticles are scarcely stuck even if those having hydrophobic characteristics are applied as the thermoplastic resin particles. In such a case, the core particle is surface-treated with a silane coupling agent in advance such that the layer treated with the silane coupling agent functions as a binder to make the core particle compatible with the thermoplastic resin microparticles, to thereby stick the thermoplastic resin microparticles to the surface of the core particle, or a wax or the like is made to precipitate together with the thermoplastic resin microparticles on the core particle, whereby the thermoplastic resin microparticles can be stuck to the surface of the core particle.

The concentration of the silane coupling agent aqueous solution used to carry out uniform surface treatment on the core particle, water-alcohol solution or aqueous acetic acid solution is adjusted to about pH 4 may be 0.01% by weight to 5% by weight.

When the concentration of the silane coupling agent is less than 0.01% by weight, the surface of the core particle is not treated sufficiently in the silane coupling treatment, and there is therefore a tendency that the thermoplastic resin microparticles are insufficiently stuck to the core particle, whereas when the concentration of the silane coupling agent exceeds 5% by weight, there is a tendency that uneven silane coupling treatment is rather carried out and also, the silane coupling agent coagulates because of the excess amount of the silane coupling agent, which cannot be dissolved in a solvent.

Using the liquid developing agent according to the fifth invention, a fluorescent plane of an image display device and further, a front substrate including this fluorescent plane may be formed in the same manner as in the first to fourth inventions.

A sectional view of the front substrate obtained in this manner is the same as that shown in FIG. 13.

Also, its plan view has the same structure as that shown in FIG. 14.

FIG. 15 shows a sectional view along the line A-A′ of FIG. 14 as an example of an FED as a display device.

### EXAMPLES

Examples according to the first to third inventions will be explained.

FIG. 16 is a schematic view showing an example of a test instrument usable in the present invention.

As illustrated, this test instrument is provided with a three-neck separable flask 30 which is vertically separable, a stirrer 136 with a stirring blade inserted into the center hole, an explosion-proof type motor 132 that rotates and drives the stirrer 136 and seals the center hole, a Dimroth reflux condenser 131 disposed in one of both holes provided in both sides of the center hole, a thermocouple 133 inserted into the separable flask 130 from the other hole, a relay temperature regulating unit 134 connected to the thermocouple 133, and a mantle heater 135 connected to the relay temperature regulating unit 134.

In this test instrument, the temperature of the content in the separable flask 130 is continuously measured using the stirrer 136. An operation of heating the mantle heater 35 is controlled by the relay temperature regulating unit 134 based on the measured temperature, thereby making it possible to maintain the content at a fixed temperature. A solvent vapor from the content is cooled and condensed by the Dimroth reflux condenser 131 and returned to the lower part of the container, whereby an excessive rise in the internal pressure in the separable flask 130 can be prevented.

### Example 1

700 g of an aqueous solution of a silane coupling agent (KBM-603, manufactured by Shin-Etsu Chemical Co., Ltd.) was prepared in a 1000 ml beaker, into which 50 g of Y₂O₂S:Eu type red emission fluorescent body particles (average particle diameter: 4.5 μm, specific gravity: 5.0) was poured and stirred for 2 hours. Then, the reaction mixture was filtered and dried at 120° C. for 3 hours in a drying furnace to carry out silane coupling treatment, followed by screening. Next, 180 g of an insulation hydrocarbon solvent (Isoper L, manufactured by Exxon Kagaku) having a boiling point range of 191 to 205° C. was poured into a 500 ml separable flask and next, 2 g of acryl microparticles (MP4009, manufactured by Soken Chemical & Engineering Co., Ltd.) having a specific gravity of 1.0 and 18 g of Y₂O₂S:Eu type red emission fluorescent body particles which had been subjected to silane coupling treatment were poured into the flask. Then, the relay temperature regulating unit used as the temperature controller was set to 100° C. and the mixture was stirred by the stirrer under heating. The stirring was continued for 2 hours under the condition of a solution temperature of 100° C. and then further continued while cooling the mixture to an ambient temperature (25° C.) over 1.5 hours. 2 g of zirconium naphthenate (manufactured by Dainippon Ink and Chemicals, Incorporated) was added to the fluorescent body particle dispersion having a solid concentration of 10% by weight which was obtained in this manner, to obtain a red emission fluorescent body-containing liquid developing agent.

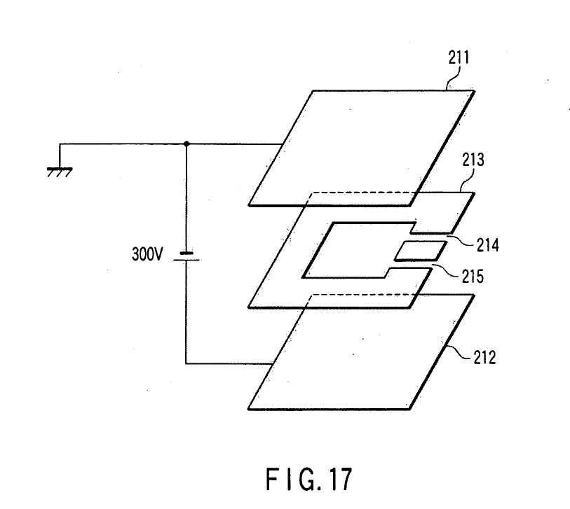

FIG. 17 is a schematic view showing an example of a test instrument for forming a toner layer by using the above liquid developing agent.

As is illustrated, a sandwich cell as the test instrument is provided with a pair of ITO electrodes 211 and 212 and a Teflon (registered trademark) spacer 213 disposed between the pair of ITO electrodes 211 and 212, wherein a voltage can be applied across these ITO electrodes 211 and 212. The Teflon spacer 213 has a form of 40 by 40 mm square and is provided with an opening of 30 by 30 mm square in the center thereof, wherein a part of the spacer 213 is removed so as to form two paths leading to the opening from one side of the spacer. One of these two paths is used as an air vent pipe 215 and the other is used as a liquid developing agent introduction path 214.

The above red emission fluorescent body-containing liquid developing agent was injected into the sandwich cell as illustrated in the figure, a DC voltage of 300V was applied for 5 seconds and then, the cell was decomposed. The state of the obtained electrodeposition film was observed, to find that a uniform fluorescent body electrodeposition film was formed on the ground side ITO electrode 211 and nothing was deposited on the positive electrode side ITO electrode 212 in all of these cases.

It was found from the above condition that these developing agents were positively charged and there was no oppositely charged developing agent. The thickness of the electrodeposition film formed on the negative electrode was 11 μm on average, to find that an electrodeposition film having a satisfactory thickness was formed.

The luminance of the fluorescent body electrodeposition film was measured by means of electron ray excitation, to find that it was almost the same as that of a fluorescent film formed by screen printing.

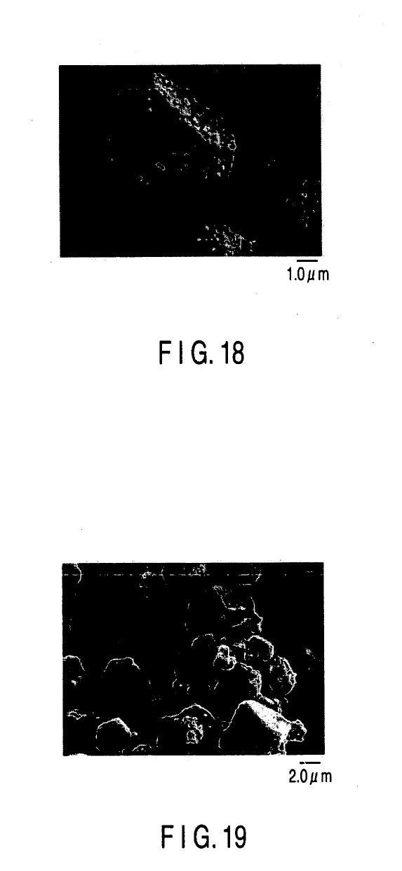

Also, a photograph of the surface structure of the toner particles of the obtained red emission fluorescent body-containing liquid developing agent was taken by SEM. FIG. 18 is a SEM photograph showing the surface structure of the toner particles. As shown in FIG. 18, it was found that the resin microparticles were uniformly stuck to the surface of the fluorescent body through the silane coupling agent.

### Example 2

700 g of an aqueous solution of a silane coupling agent (KBM-603, manufactured by Shin-Etsu Chemical Co., Ltd.) was prepared in a 1000 ml beaker, into which 50 g of ZnS:Cu, Al type green emission fluorescent body particles (average particle diameter: 5.6 μm, specific gravity: 4.1) was poured and stirred for 2 hours. Then, the reaction mixture was filtered and dried at 120° C. for 3 hours in a drying furnace, followed by screening. Next, 180 g of an insulation hydrocarbon solvent (Isoper L, manufactured by Exxon Kagaku) having a boiling point range of 191 to 205° C. was poured into a 500 ml separable flask and next, 2 g of acryl microparticles (MP4009, manufactured by Soken Chemical & Engineering Co., Ltd.) having a specific gravity of 1.0 and 18 g of ZnS:Cu, Al type green emission fluorescent body particles which had been subjected to silane coupling treatment were poured into the separable flask. Then, the relay temperature regulating unit used as the temperature controller was set to 100° C. and the mixture was stirred by the stirrer under heating. The stirring was continued for 2 hours under the condition of a solution temperature of 100° C. and then further continued while cooling the mixture to an ambient temperature (25° C.) over 1.5 hours. 2 g of zirconium naphthenate (manufactured by Dainippon Ink and Chemicals, Incorporated) was added to the fluorescent body particle dispersion having a solid concentration of 10% by weight which was obtained in this manner, to obtain a green emission fluorescent body-containing liquid developing agent.

The above green emission fluorescent body-containing liquid developing agent was injected into the sandwich cell, a DC voltage of 300V was applied for 5 seconds and then, the cell was decomposed. The state of the obtained electrodeposition film was observed, to find that a uniform fluorescent body electrodeposition film was formed on the ground side ITO electrode and nothing was deposited on the positive electrode side ITO electrode in all of these cases.

It was found from the above condition that these developing agents were positively charged and there was no oppositely charged developing agent. The thickness of the electrodeposition film formed on the negative electrode was 12 μm on average, to find that an electrodeposition film having a satisfactory thickness was formed.

The luminance of the fluorescent body electrodeposition film was measured by means of electron ray excitation, to find that it was almost the same as that of a fluorescent film formed by screen printing.

### Example 3

700 g of an aqueous solution of a silane coupling agent (KBM-603, manufactured by Shin-Etsu Chemical Co., Ltd.) was prepared in a 1000 ml beaker, into which 50 g of ZnS:Ag, Al type blue emission fluorescent body particles (average particle diameter: 5.6 μm, specific gravity: 4.1) was poured and stirred for 2 hours. Then, the reaction mixture was filtered and dried at 120° C. for 3 hours in a drying furnace, followed by screening. Next, 180 g of an insulation hydrocarbon solvent (Isoper L, manufactured by Exxon Kagaku) having a boiling point range of 191 to 205° C. was poured into a 500 ml separable flask and next, 2 g of acryl microparticles (MP4009, manufactured by Soken Chemical & Engineering Co., Ltd.) having a specific gravity of 1.0 and 18 g of ZnS:Ag, Al type blue emission fluorescent body particles were poured into the flask. Then, the relay temperature regulating unit used as the temperature controller was set to 100° C. and the mixture was stirred by the stirrer under heating. The stirring was continued for 2 hours under the condition of a solution temperature of 100° C. and then further continued while cooling the mixture to ambient temperature (25° C.) over 1.5 hours. 2 g of zirconium naphthenate (manufactured by Dainippon Ink and Chemicals, Incorporated) was added to the fluorescent body particle dispersion having a solid concentration of 10% by weight which was obtained in this manner, to obtain a blue emission fluorescent body-containing liquid developing agent.

The above blue emission fluorescent body-containing liquid developing agent was injected into the sandwich cell, a DC voltage of 300V was applied for 5 seconds and then, the cell was decomposed. The state of the obtained electrodeposition film was observed, to find that a uniform fluorescent body electrodeposition film was formed on the ground side ITO electrode and nothing was deposited on the positive electrode side ITO electrode in all of these cases.

It was found from the above condition that these developing agents were positively charged and there was no oppositely charged developing agent. The thickness of the electrodeposition film formed on the negative electrode was 12 μm on average, to find that an electrodeposition film having a satisfactory thickness was formed.

The luminance of the fluorescent body electrodeposition film was measured by means of electron ray excitation, to find that it was almost the same as that of a fluorescent film formed by screen printing.

The red emission fluorescent body-containing liquid developing agent, green emission fluorescent body-containing liquid developing agent and blue emission fluorescent body-containing liquid developing agent obtained in the above Examples 1 to 3 were put in the developing units 3r, 3g and 3b having the same structures as those shown in FIG. 3, respectively. A 10 mm×100 mm master plate having a pattern in which a large number of 147-μm-wide and 247-μm-long dots were arranged in line was applied to carry out developing, drying and transfer operations, to form a red emission fluorescent body layer, green emission fluorescent body layer and blue emission fluorescent body layer on a transparent substrate having a size of 10 mm×10 mm.

30 measurements of the width of each of the obtained fluorescent body layers were taken, at random, to calculate the standard deviation thereof. The average lateral width was found to be 151.72 μm and the standard deviation was 1.66.

Also, the transfer ratio was found from the volume or weight of each of the transferred fluorescent body layers and the volume or weight of the dried liquid developing agent stuck to each dot-like pattern of the master plate before transfer by using the following equation.

Transfer ratio (%)=(volume or weight of each fluorescent body layer/volume or weight of the dried liquid developing agent stuck to each dot-like pattern of the master plate)×100

As a result, the transfer ratio was 99.47%.

### Test Example 1

Next, 180 g of an insulation hydrocarbon solvent (Isoper L, manufactured by Exxon Kagaku) having a boiling point range of 191 to 205° C. was poured into a 500 ml separable flask and next, 2 g of an ethylene/vinyl acetate copolymer type wax (371FP) (manufactured by Clariant (Japan) K.K.) having a melting point of 99° C. to 105° C. and a specific gravity of 0.96, 18 g of Y₂O₂S:Eu type red emission fluorescent body particles (average particle diameter: 4.5 μm and specific gravity: 5.0) which had not been subjected to a silane coupling treatment and 2 g of acryl microparticles (MP4009, manufactured by Soken Chemical & Engineering Co., Ltd.) were poured into the flask. Then, the relay temperature regulating unit 34 used as the temperature controller was set to 150° C. and the mixture was stirred by the stirrer 36 under heating. When the temperature of the solution reached 150° C., the above wax component was completely melted and dissolved in the solvent. The stirring was continued for 2 hours under the condition that the solution temperature was 150° C. and then further continued while cooling the mixture to an ambient temperature (25° C.) over 1.5 hours. 2 g of zirconium naphthenate (naphthenate Zr, manufactured by Dainippon Ink and Chemicals, Incorporated) was added to the fluorescent body particle dispersion having a solid concentration of 10% by weight which was obtained in this manner, to obtain a red emission fluorescent body-containing liquid developing agent.

The conductivity of the toner particles in each of the obtained developing agents, that is, with the developing agent containing wax and containing no wax, as in Example 1, was examined by a conductivity meter (M-627, manufactured by Scientifica), to find that the conductivity of the toner particles containing wax was 64 (pS/cm) and the conductivity of the toner particles containing no wax was 315 (pS/cm).

From the above results, the toner particles containing no wax, like the case of Example 1, were superior in conductivity to the toner particles containing wax, like the case of Test Example 1, because the charge control agent to be added was sufficiently adsorbed. Based on this result, it can be seen that a thick developing agent layer can be electrodeposited with high accuracy. Also, it was found that when a developing agent layer electrodeposited on an adherent was transferred to another adherent, the developing agent layer had good releasability.

Also, a photograph of the surface structure of the toner particles of the obtained red emission fluorescent body-containing liquid developing agent was taken by SEM to observe. FIG. 19 is a SEM photograph showing the surface structure of the toner particles. As shown in FIG. 19, the toner particles were covered with wax bled on the surface. Therefore, it was considered that these toner particles were more deteriorated in charging ability than the toner particles containing no wax which were obtained in Example 1.

### Test Example 2

A green emission fluorescent body-containing liquid developing agent was obtained in the same manner as in Test Example 1 except that 18 g of ZnS:Cu, Al type green emission fluorescent body particles was used in place of 18 g of Y₂O₂S:Eu type red emission fluorescent body particles (average particle diameter: 4.5 μm and specific gravity: 5.0) which had not been subjected to silane coupling treatment.

### Test Example 3

A blue emission fluorescent body-containing liquid developing agent was obtained in the same manner as in Test Example 1 except that 18 g of ZnS:Ag, Al type blue emission fluorescent body particles was used in place of 18 g of Y₂O₂S:Eu type red emission fluorescent body particles (average particle diameter: 4.5 μm and specific gravity: 5.0) which had not been subjected to silane coupling treatment.

The red emission fluorescent body-containing liquid developing agent containing wax, green emission fluorescent body-containing liquid developing agent containing wax and blue emission fluorescent body-containing liquid developing agent containing wax, which were obtained in the above Test Examples 1 to 3, were put in the developing units 3r, 3g and 3b having the same structures as those shown in FIG. 3, respectively, in the same manner as the liquid developing agents obtained in Examples 1 to 3. A 10 mm×100 mm master plate having a pattern in which a large number of 147-μm-wide and 247-μm-long dots were arranged in line was applied to carry out developing, drying and transfer operations, to form a red emission fluorescent body layer, green emission fluorescent body layer and blue emission fluorescent body layer on a transparent substrate.

30 measurements of the width of each of the obtained. The average lateral width was found to be 139.72 μm and the standard deviation was 22.4.

Also, the transfer ratio of the toner particles was found in the same manner as in the above Examples 1 to 3, to find that the transfer ratio was 84.36%. It was found from this result that the liquid developing agent containing no wax was superior in transfer ratio to the liquid developing agent containing wax.

It was found from this result that if a liquid developing agent containing no wax was used, a fluorescent body layer having a size corresponding to the size of the dot of the master plate was transferred, and the dispersion in the dot shape of the resulting fluorescent body layer was small because the standard deviation in dot size was low, showing that the pattern accuracy was good. On the other hand, in the case of using the liquid developing agent containing wax, the transfer operation was insufficiently carried out and the dispersion in the dot shape of the resulting fluorescent body layer was large because the standard deviation in dot size was high, showing that the pattern accuracy was unsatisfactory.

Next, examples according to the fourth invention will be shown.

Here, the same test instrument as that shown in FIG. 16 was used.

### Example 4

180 g of an insulation hydrocarbon solvent (Isoper L, manufactured by Exxon Kagaku) having a boiling point range of 191 to 205° C. was poured into a 500 ml separation flask shown in the figure. Then, 2 g of acryl microparticles (MP4009, manufactured by Soken Chemical & Engineering Co., Ltd.) having an average particle diameter of 0.4 μm, a softening point of 80° C. and a specific gravity of 1.0, and 18 g of ZnS:Cu, Al type green emission fluorescent body particles (average particle diameter: 5.6 μm) were poured into the flask. Then, the temperature controller was set to 100° C. and the mixture was stirred under heating. The mixture was stirred continuously at a fixed temperature for 2 hours also after the solution temperature reached 100° C. Then, the stirring was continued while cooling the mixture to an ambient temperature (25° C.) over 1.5 hours. 1.0 g of gadolinium octylate (manufactured by Nihon Kagaku Sangyo Co., Ltd.) was added as a charge control agent to the fluorescent body particle dispersion having a solid concentration of 10% by weight which was obtained in this manner, to obtain a green emission fluorescent body-containing liquid developing agent.

With regard to the green emission fluorescent body-containing liquid developing agent, its conductivity and the state of an electrodeposition film formed using this liquid developing agent were examined for 30 days just after the charge control agent was added. The obtained results are shown in the following Table 1.

The conductivity of the toner particles in the developing agent was measured by a conductivity meter (M-627, manufactured by Scientifica).

The electrodeposition film formed was evaluated as follows.

The above green emission fluorescent body-containing liquid developing agent was injected into the sandwich cell as shown in FIG. 17, DC voltages of 200V and 800V were respectively applied for 5 seconds and then, the cell was decomposed. The state of the obtained electrodeposition film was observed, to find that a uniform fluorescent body electrodeposition film was formed on the ground side ITO electrode 211 and nothing was deposited on the positive electrode side ITO electrode 212 in all of these cases.

The variation in conductivity with time was small and the conductivity was stable, thus showing that gadolinium octylate imparted stable charging characteristics to the surface of the core particle from the start of the addition of gadolinium octylate.

It was found from the above fact that all the developing agents were positively charged, and that no uncharged particles or particles having lost their charging ability over time existed.

The obtained electrodeposition film was evaluated as follows: where no particle residue was present on the positive electrode side, this was rated as ◯; where particle residue was present on the positive electrode side, this was rated as Δ; and where particle residue was present on the positive electrode side at 50% or more, this was rated as X. The results are shown in Table 1 below.

TABLE 1

| | | After | After | After | After | After | After |
|---|---|---|---|---|---|---|---|
| | Just after | 5 | one | 3 | 5 | 10 | 30 |
| | addition | hours | day | days | days | days | days |
| Conductivity | 76 | 78 | 77 | 78 | 75 | 75 | 76 |
| (pS/cm) | | | | | | | |
| 200 V | ◯ | ◯ | ◯ | ◯ | ◯ | ◯ | ◯ |
| electrodeposition | | | | | | | |
| film | | | | | | | |
| 800 V | ◯ | ◯ | ◯ | ◯ | ◯ | ◯ | ◯ |
| electrodeposition | | | | | | | |
| film | | | | | | | |

Here, the softening point means the temperature of a heat transfer medium obtained when a needle indenter penetrates to a depth of 1 mm after the temperature of the medium is raised at a fixed rate while applying a given load through the needle indenter placed vertically on a test piece placed in a heating bath or heating vessel, as indicated in JIS K 7206: 1999 Plastic-Thermoplastic materials-determination of Vicat softening temperature (VST) (ISO 306: 1994).

### Example 5

A green emission fluorescent body-containing liquid developing agent was obtained in the same manner as above except that 11.0 g of lanthanum octylate (manufactured by Nihon Kagaku Sangyo Co., Ltd.) was added as the charge control agent.

With regard to the obtained green emission fluorescent body-containing liquid developing agent, its conductivity was measured and the electrodeposition film was evaluated in the same manner as in Example 4. The results are shown in Table 2 below.

TABLE 2

| | | After | After | After | After | After | After |
|---|---|---|---|---|---|---|---|
| | Just after | 5 | one | 3 | 5 | 10 | 30 |
| | addition | hours | day | days | days | days | days |
| Conductivity | 98 | 98 | 102 | 97 | 98 | 98 | 98 |
| (pS/cm) | | | | | | | |
| 200 V | ◯ | ◯ | ◯ | ◯ | ◯ | ◯ | ◯ |
| electrodeposition | | | | | | | |
| film | | | | | | | |
| 800 V | ◯ | ◯ | ◯ | ◯ | ◯ | ◯ | ◯ |
| electrodeposition | | | | | | | |
| film | | | | | | | |

The variation in conductivity with time was small and the conductivity was stable, thus showing that lanthanum octylate imparted stable charging characteristics to the surface of the core particle from the start of the addition of lanthanum octylate.

As to the electrodeposition film, a uniform fluorescent body electrodeposition film was formed on the ground side ITO electrode and nothing was deposited on the positive electrode side ITO electrode in all of these cases.

It was found from the above fact that all the developing agents were positively charged, and that no uncharged particles or particles having lost their charging ability over time existed.

### Comparative Example 1

A green emission fluorescent body-containing liquid developing agent was obtained by adding 11.0 g of zirconium naphthenate (manufactured by Dainippon Ink and Chemicals, Incorporated) as the charge control agent.

With regard to the obtained green emission fluorescent body-containing liquid developing agent, its conductivity was measured and the electrodeposition film was evaluated in the same manner as in Example 4. The results are shown in Table 3 below.

TABLE 3

| | | After | After | After | After | After | After |
|---|---|---|---|---|---|---|---|
| | Just after | 5 | one | 3 | 5 | 10 | 30 |
| | addition | hours | day | days | days | days | days |
| Conductivity | 154 | 106 | 92 | 85 | 85 | 84 | 70 |
| (pS/cm) | | | | | | | |
| 200 V | Δ | Δ | ◯ | ◯ | ◯ | ◯ | Δ |
| electrodeposition | | | | | | | |
| film | | | | | | | |
| 800 V | Δ | ◯ | ◯ | ◯ | ◯ | ◯ | Δ |
| electrodeposition | | | | | | | |
| film | | | | | | | |

The variation in conductivity in, particularly, the initial stage of the addition is large, which suggests that stable charging characteristics cannot be imparted to the surface of the core particle.

As to the electrodeposition film, such a phenomenon was observed that a uniform fluorescent electrodeposition film was not formed on the ground side ITO electrode and the particles also remained on the positive electrode side ITO electrode. It is considered that, when this phenomenon is observed in the initial stage of the addition, there is a high presence of zirconium naphthenate which is not oriented on the surface of the particle, so that uncharged particles exist because the adsorption equilibrium reaction with the surface of the particle is slow. It is also considered that, when this phenomenon is observed in the last stage of the addition, the stability of the adsorption equilibrium with the surface of the particle is low, and therefore, the charge imparting characteristics are deteriorated with time.

### Comparative Example 2

A green emission fluorescent body-containing liquid developing agent was obtained by adding 11.0 g of titanium octylate (manufactured by Nihon Kagaku Sangyo Co., Ltd.) as the charge control agent.

With regard to the obtained green emission fluorescent body-containing liquid developing agent, its conductivity was measured and the electrodeposition film was evaluated in the same manner as in Example 4. The results are shown in Table 4 below.

TABLE 4

| | | After | After | After | After | After | After |
|---|---|---|---|---|---|---|---|
| | Just after | 5 | one | 3 | 5 | 10 | 30 |
| | addition | hours | day | days | days | days | days |
| Conductivity | 136 | 92 | 85 | 75 | 75 | 75 | 70 |
| (pS/cm) | | | | | | | |
| 200 V | X | Δ | ◯ | ◯ | ◯ | Δ | Δ |
| electrodeposition | | | | | | | |
| film | | | | | | | |
| 800 V | Δ | Δ | ◯ | ◯ | ◯ | ◯ | Δ |
| electrodeposition | | | | | | | |
| film | | | | | | | |

The variation in conductivity in, particularly, the initial stage of the addition is large, which suggests that stable charging characteristics cannot be imparted to the surface of the core particle.

As to the electrodeposition film, such a phenomenon was observed that a uniform fluorescent electrodeposition film was not formed on the ground side ITO electrode and that particles also remained on the positive electrode side ITO electrode. It is considered that, when this phenomenon is observed in the initial stage of the addition, there is a high presence of titanium octylate which is not oriented on the surface of the particle, so that uncharged particles exist because the adsorption equilibrium reaction with the surface of the particle is slow. It is also considered that, when this phenomenon is observed in the last stage of the addition, the stability of the adsorption equilibrium with the surface of the particle is low, and therefore, the charge imparting characteristics are deteriorated with time.

### Example 6

A red emission fluorescent body-containing liquid developing agent was obtained in the same manner as in Example 1 except that the amount of the acryl microparticles (MP4009) was altered to 1 g and 19 g of Y₂O₂S:Eu type red emission fluorescent body particles (average particle diameter: 4.3 μm) was poured in place of ZnS:Cu, Al type green emission fluorescent body particles.

With regard to the thus obtained red emission fluorescent body-containing liquid developing agent, its conductivity and the state of an electrodeposition film formed were examined in the same manner as in Example 1 when the developing agent was stored at 10° C., 25° C. and 50° C. for one day, three days, and ten days. The results are shown in Table 5 below.

TABLE 5

| | After | After | After |
|---|---|---|---|
| | one day | 3 days | 10 days |
| Stored at 10° C. | ◯ | ◯ | ◯ |
| Stored at 25° C. | ◯ | ◯ | ◯ |
| Stored at 50° C. | ◯ | ◯ | ◯ |

With regard to the electrodeposition film, the developing agent solution was injected into a sandwich cell, a DC voltage of 800V was applied for 5 seconds and then, the cell was decomposed, to observe the state of the obtained electrodeposition film.

As to the electrodeposition film, a uniform fluorescent body electrodeposition film was formed on the ground side ITO electrode and nothing was deposited on the positive electrode side ITO electrode in all of these cases.

This implies that all the developing agents were positively charged, and that no uncharged particles or particles having lost their charging ability over time existed.

### Comparative Example 3

A red emission fluorescent body-containing liquid developing agent was obtained in the same manner as in Example 6 except that 11.0 g of titanium octylate (manufactured by Nihon Kagaku Sangyo Co., Ltd.) was used as the charge control agent.

With regard to the obtained red emission fluorescent body-containing liquid developing agent, its conductivity and the state of an electrodeposition film formed were examined in the same manner as in Example 1 when the developing agent was stored at 10° C., 25° C. and 50° C. for one day, three days, and ten days. The results are shown in Table 6 below.

TABLE 6

| | After | After | After |
|---|---|---|---|
| | one day | 3 days | 10 days |
| Stored at 10° C. | ◯ | ◯ | Δ |
| Stored at 25° C. | ◯ | ◯ | ◯ |
| Stored at 50° C. | Δ | X | X |

As to the electrodeposition film, a uniform fluorescent body electrodeposition film was not formed on the ground side ITO electrode and particles were also left on the positive electrode side ITO electrode.

The reason for the deterioration in electrodeposition characteristics when the developing agent is stored at 50° C. is considered to be that the surface state is easily varied by the activation of the resin on the surface of the core particle and therefore, the condition of adsorption of titanium octylate is not stabilized. The reason for the deterioration in electrodeposition characteristics when the developing agent is stored at 10° C. is considered to be that a delay of the adsorption equilibrium reaction of titanium octylate causes an unstable charging condition.

Next, examples according the fifth invention will be explained.

Here, the same test instrument as that shown in FIG. 16 is used.

### Example 7

180 g of an insulation hydrocarbon solvent (Isoper L, manufactured by Exxon Kagaku) having a boiling point range of 191 to 205° C. was poured into a 500 ml separable flask shown in the figure and next, 2 g of acryl resin microparticles (MP4009, manufactured by Soken Chemical & Engineering Co., Ltd.) having an average particle diameter of 0.4 μm, a softening point of 80° C. and a specific gravity of 1.0, and 18 g of ZnS:Cu, Al type green emission fluorescent body particles (average particle diameter: 5.6 μm) were poured into the flask. Then, the temperature controller was set to 100° C. and the mixture was stirred under heating. The mixture was stirred continuously at a fixed temperature for 2 hours also after the solution temperature reached 100° C. Then, the stirring was continued while cooling the mixture to an ambient temperature (25° C.) over 1.5 hours. 2.0 g of magnesium octylate (manufactured by Nihon Kagaku Sangyo Co., Ltd.) was added as a charge control agent to the fluorescent body particle dispersion having a solid concentration of 10% by weight which was obtained in this manner, to obtain a green emission fluorescent body-containing liquid developing agent.

Using the obtained green emission fluorescent body-containing liquid developing agent, a fluorescent body layer having a film thickness of about 10 μm was formed on a glass substrate (100 mm×100 mm) by an electrophoretic method. A metal back layer of 120 nm in film thickness was formed by deposition of Al on the fluorescent body layer to make a sample for measuring emission characteristics.

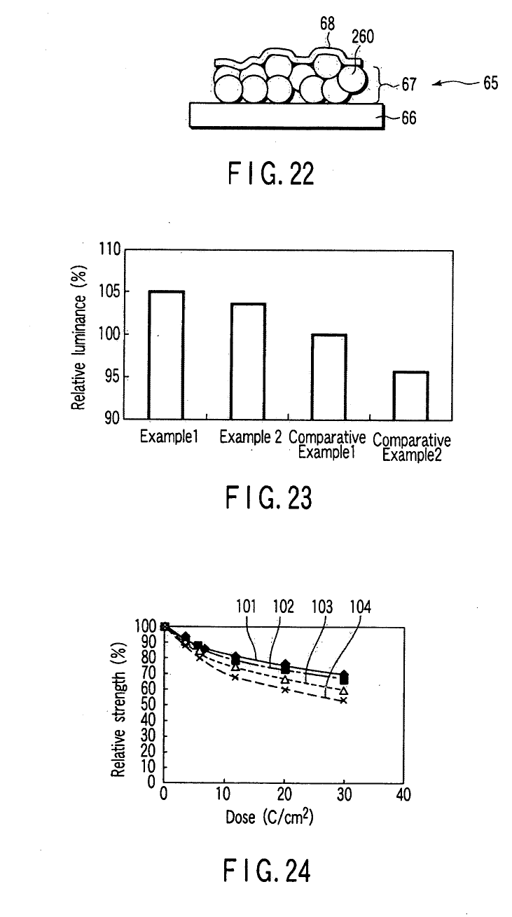

FIG. 22 is a typical view showing the structure of a sample used to measure emission characteristics.

As is illustrated, this sample 65 is provided with a glass substrate 66, a coating layer 67 made of acryl resin microparticles 260 and formed on the glass substrate 66, and a metal back layer 68 formed on the coating layer 67.

Electron rays having an acceleration voltage of 10 kV and a current density of 0.36 A/mm² (current: 250 A, luster size: 10 mm×70 mm) were irradiated on the sample to make the fluorescent body emit light, thereby measuring the emission luminance. Also, in order to evaluate the emission life, electron rays were applied continuously to measure the variation in emission luminance as a function of the dose of electron rays.

The initial emission luminance is shown in graph of FIG. 23.

Graph 101 in FIG. 24 shows the relationship between the dose of electron rays and the emission luminance.

A spectral radiation instrument SR-3A manufactured by Topcon Technohouse was used to measure the emission luminance.

### Example 8

A green emission fluorescent body-containing liquid developing agent was obtained in the same manner as in Example 7 except that 2.0 g of gadolinium octylate (manufactured by Nihon Kagaku Sangyo Co., Ltd.) was added in place of 2.0 g of magnesium octylate (also manufactured by Nihon Kagaku Sangyo Co., Ltd.).

Using the obtained green emission fluorescent body-containing liquid developing agent, the same procedures as in Example 7 were performed to make a sample for measuring emission characteristics.

Using the obtained sample, the emission luminance was measured in the same manner as in Example 7. The initial emission luminance is shown in FIG. 23 and the variation in emission luminance as a function of the dose of electron rays is shown in graph 102 of FIG. 24.

### Comparative Example 4

A green emission fluorescent body dispersion solution having a solid concentration of 10% by weight was obtained in the same manner as in Example 7 except that no charge control agent was added.

Using the obtained green emission fluorescent body dispersion solution, a fluorescent body layer having a film thickness of about 10 μm was formed on a glass substrate (100 mm×100 mm) by a precipitation deposition method. A metal back layer of about 120 nm in film thickness, which was formed by Al deposition, was formed on the upper surface of the fluorescent body layer to make a sample used to measure the emission characteristics.

Using the obtained sample, the emission luminance was measured in the same manner as in Example 7. The initial emission luminance is shown in FIG. 23 and the variation in emission luminance as a function of the dose of electron rays is shown in graph 103 of FIG. 24.

It was found that Example 7 was more improved in emission luminance by about 5.0% than this comparative example, as shown in FIG. 23.

Also, the emission life was more improved by about 11% in the case of Example 7 than in the case of Comparative Example 4 when the life is defined as the maintenance factor of the peak strength of the emission spectrum at a dose of 20 C/cm² as shown in FIG. 24.

It was found that Example 2 was more improved in emission luminance by about 3.5% than Example 8 as shown in FIG. 23.

Also, the emission life was more improved by about 9% in the case of Example 7 than in the case of Comparative Example 4, when the life is defined as the maintenance factor of the peak strength of the emission spectrum at a dose of 20 C/cm² as shown in FIG. 24.

### Comparative Example 5

A green emission fluorescent body-containing liquid developing agent was obtained in the same manner as in Example 7 except that 2.0 g of zirconium naphthenate (manufactured by Dainippon Ink and Chemicals, Incorporated) was added in place of 2.0 g of magnesium octylate (manufactured by Nihon Kagaku Sangyo Co., Ltd.).

Using the obtained green emission fluorescent body-containing liquid developing agent, the same procedures as in Example 7 were performed to make a sample for measuring emission characteristics.

Using the obtained sample, the emission luminance was measured in the same manner as in Example 7. The initial emission luminance is shown in FIG. 23 and the variation in emission luminance as a function of the dose of electron rays is shown in graph 104 of FIG. 24.

This example was more deteriorated in emission luminance by about 4.5% than Comparative Example 4 as, shown in FIG. 23.

Also, the emission life was more deteriorated by about 12% in the case of this example than in the case of Comparative Example 4 when the life is defined as the maintenance factor of the peak strength of the emission spectrum at a dose of 20 C/cm².

This is considered to be because transition metal components such as zirconium act as so-called killer materials which enter the emission site of the ZnS mother body to thereby deteriorate the emission characteristics of the fluorescent body.

### Example 9

A blue emission fluorescent body-containing liquid developing agent was obtained in the same manner as in Example 7 except that 18 g of ZnS:Ag, Cl type blue emission fluorescent body particles (average particle diameter: 6.5 μm) were used in place of ZnS:Cu, Al type green emission fluorescent body particles.

Using the obtained blue emission fluorescent body-containing liquid developing agent, the same procedures as in Example 7 were performed to make a sample for measuring emission characteristics.

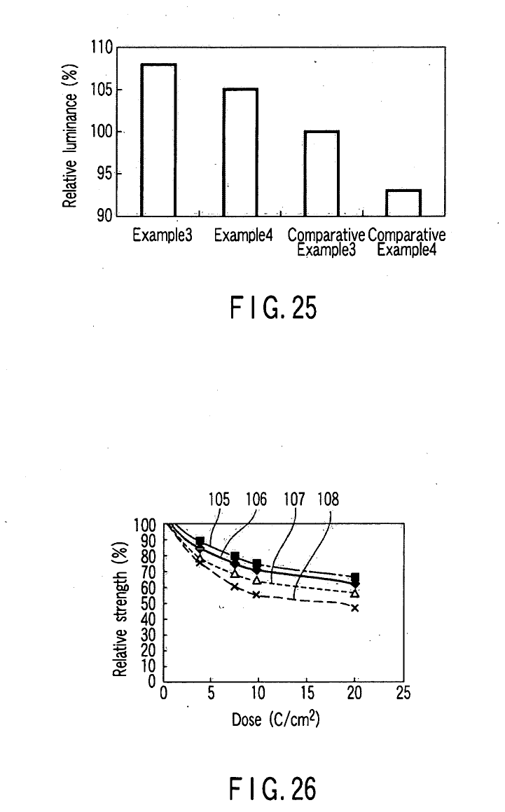

Using the obtained sample, the emission luminance was measured in the same manner as in Example 7. The initial emission luminance is shown in FIG. 25 and the variation in the emission luminance as a function of the dose of electron rays is shown in graph 105 of FIG. 26.

Example 9 was more improved in emission luminance by about 8.0% than Comparative Example 6 as shown in FIG. 25.

Also, the emission life was more improved by about 11% in the case of this example than in the case of Comparative Example 6 when the life is defined as the maintenance factor of the peak strength of the emission spectrum at a dose of 20 C/cm².

### Example 10

A blue emission fluorescent body-containing liquid developing agent was obtained in the same manner as in Example 9 except that 2.0 g of lanthanum octylate (manufactured by Nihon Kagaku Sangyo Co., Ltd.) was added in place of 2.0 g of magnesium octylate (also manufactured by Nihon Kagaku Sangyo Co., Ltd.).

Using the obtained blue emission fluorescent body-containing liquid developing agent, the same procedures as in Example 9 were performed to make a sample for measuring emission characteristics.

Using the obtained sample, the emission luminance was measured in the same manner as in Example 7. The initial emission luminance is shown in FIG. 25 and the variation in emission luminance as a function of the dose of electron rays is shown in graph 106 of FIG. 26.

Example 10 was more improved in emission luminance by about 5.0% than Comparative Example 6 as shown in FIG. 25.

Also, the emission life was more improved by about 18% in the case of this example than in the case of Comparative Example 6 when the life is defined as the maintenance factor of the peak strength of the emission spectrum at a dose of 20 C/cm².

### Comparative Example 6

A green emission fluorescent body dispersion solution having a solid concentration of 10% by weight was obtained in the same manner as in Example 9 except that no charge control agent was added.

Using the green emission fluorescent body dispersion solution, a fluorescent body layer having a film thickness of about 10 μm was formed on a glass substrate (100 mm×100 mm) by a precipitation deposition method. A metal back layer of about 120 nm in film thickness, which was formed by Al deposition, was formed on the upper surface of the fluorescent body layer to make a sample used to measure the emission characteristics.

Using the obtained sample, the emission luminance was measured in the same manner as in Example 7. The initial emission luminance is shown in FIG. 25 and the variation in emission luminance as a function of the dose of electron rays is shown in graph 107 of FIG. 26.

It was found that Example 6 was more improved in emission luminance by about 8.0% than Example 9 as shown in FIG. 24.

Also, the emission life was more improved by about 11% in the case of Example 9 than in the case of Comparative Example 6 when the life is defined as the maintenance factor of the peak strength of the emission spectrum at a dose of 20 C/cm² as shown in FIG. 24.

### Comparative Example 7

A green emission fluorescent body-containing liquid developing agent was obtained in the same manner as in Example 9 except that 2.0 g of zirconium naphthenate (manufactured by Dainippon Ink and Chemicals, Incorporated) was added in place of 2.0 g of magnesium octylate (manufactured by Nihon Kagaku Sangyo Co., Ltd.).

Using the obtained green emission fluorescent body-containing liquid developing agent, a sample for measuring emission characteristics was made in the same manner as in Example 7.

Using the obtained sample, the emission luminance was measured in the same manner as in Example 7. The initial emission luminance is shown in FIG. 19 and the variation in emission luminance as a function of the dose of electron rays is shown in graph 108 of FIG. 26.

It was found that this example was more deteriorated in emission luminance by about 7.0% than Comparative Example 6 as shown in FIG. 25.

Also, the emission life was more deteriorated by about 15% in the case of this example than in the case of Comparative Example 6 when the life is defined as the maintenance factor of the peak strength of the emission spectrum at a dose of 20 C/cm².

This is considered to be because transition metal components such as zirconium act as so-called killer materials that enter the emission site of the ZnS mother body to thereby deteriorate the emission characteristics.

What is claimed is:

1. A liquid developing agent comprising:
an electric insulation solvent; and
toner particles included in the electric insulation solvent and containing core particles having an average particle diameter of 1 to 10 μm, a silane coupling agent treatment layer disposed on the surface of the core particle, a coating layer of thermoplastic resin microparticles disposed on the surface of the core particle through the silane coupling agent treatment layer and a charge control agent added to the surface of the core particle coated with the thermoplastic resin microparticles.

2. The liquid developing agent according to claim 1, wherein the silane coupling agent contains at least one functional group having high reactivity with the thermoplastic resin microparticles and selected from an acryloxy group, an epoxy group, an amino group, a methacryloxy group and a styryl group.

3. The liquid developing agent according to claim 1, wherein the charge control agent is at least one type selected from the group consisting of a metal soap, a surfactant, and a metal alkoxide.

4. The liquid developing agent according to claim 1, wherein the core particle is made of a fluorescent body particle.

5. The liquid developing agent according to claim 1, wherein the thermoplastic resin microparticles have an average particle diameter of 0.1 to 5 μm.

6. A liquid developing agent comprising:
an electric insulation solvent; and
toner particles included in the electric insulation solvent and containing core particles, a coating layer of thermoplastic resin microparticles disposed on the surface of the core particle and an organic metal compound containing at least one lanthanoid metal and added as a charge control agent to the surface of the core particle coated with the thermoplastic resin microparticles.

7. The liquid developing agent according to claim 6, wherein the core particles have an average particle diameter of 0.01 to 10 μm.

8. The liquid developing agent according to claim 6, wherein an amount of the organic metal compound to be added corresponds to 0.001 to 10% by weight of the metal based on the weight of the core particles.

9. The liquid developing agent according to claim 6, wherein the organic metal compound has 6 to 30 carbon atoms.

10. The liquid developing agent according to claim 6, wherein the thermoplastic resin microparticles have an average particle diameter of 0.1 to 5 μm.

11. The liquid developing agent according to claim 6, wherein the thermoplastic resin microparticles are added in an amount of 1 to 20% by weight based on the weight of the core particles.

12. A liquid developing agent comprising:
an electric insulation solvent; and
toner particles included in the electric insulation solvent and containing core particles made of a zinc sulfide type fluorescent body, a coating layer of thermoplastic resin microparticles disposed on the surface of the core particle and a metal compound containing at least one of IIA group and IIIA group metals and added as a charge control agent to the surface of the core particle coated with the thermoplastic resin microparticles.

13. The liquid developing agent according to claim 12, wherein the core particles have an average particle diameter of 1 to 10 μm.

14. The liquid developing agent according to claim 12, wherein the metal compound is a metal organic acid salt having 6 to 30 carbon atoms.

15. The liquid developing agent according to claim 12, wherein the metal compound contains a metal in an amount of 0.001 to 10% by weight based on the weight of the core particles.

16. The liquid developing agent according to claim 12, wherein the thermoplastic resin microparticles have an average particle diameter of 0.1 to 5 μm.

17. The liquid developing agent according to claim 12, wherein the average diameter of the thermoplastic resin microparticles is less than the average particle diameter of the core particles.

18. The liquid developing agent according to claim 12, wherein the thermoplastic resin microparticles are added in an amount of 1 to 20% by weight based on the weight of the core particles.

19. A method of producing a liquid developing agent, the method comprising:
carrying out a silane coupling treatment on a surface of core particles having an average particle diameter of 1 to 10 μm to form a silane coupling agent treatment layer;
stirring, in an electric insulation solvent, the core particles treated by the silane coupling treatment and thermoplastic resin microparticles which are substantially insoluble in the electric insulation solvent and have a smaller average particle diameter than the core particle at a temperature less than the boiling point of the electric insulation solvent to make the thermoplastic resin microparticles stick to the surface of the core particle treated by silane coupling treatment, thereby forming a coating layer of thermoplastic resin microparticles; and
applying a charge control agent to the electric insulation solvent containing the core particles coated with the thermoplastic resin microparticles to add the charge control agent to the surface of the core particle coated with the thermoplastic resin microparticles.

20. The method of producing a liquid developing agent according to claim 19, wherein the silane coupling agent contains at least one functional group having high reactivity with the thermoplastic resin microparticles and selected from an acryloxy group, an epoxy group, an amino group, a methacryloxy group and a styryl group.

21. The method of producing a liquid developing agent according to claim 19, wherein the thermoplastic resin microparticles have an average particle diameter of 0.1 to 5 μm.

22. The method of producing a liquid developing agent according to claim 19, wherein the charge control agent is at least one type selected from the group consisting of a metal soap, a surfactant and a metal alkoxide.

23. A method of producing a display device, the method comprising a process of forming a front substrate, the process comprising:
forming a light shielding layer having a plurality of frame or stripe patterns;
developing to supply a liquid developing agent including an electric insulation solvent and toner particles included in the electric insulation solvent and containing core particles having an average particle diameter of 1 to 10 μm, a silane coupling agent treatment layer disposed on the surface of the core particle, a coating layer of thermoplastic resin microparticles disposed on the surface of the core particle through the silane coupling agent treatment layer and a charge control agent added to the surface of the core particle coated with the thermoplastic resin microparticles, to the surface of an image support through a supply member, and forming an electric field between the supply member and the image support to form a dot or stripe pattern image on the surface of the image support;
rolling the image support on which a pattern image has been formed using the liquid developing agent along a transparent substrate held at a fixed position and having a light-shielding layer;
transferring to form an electric field between the rolled image support and the transparent substrate and transferring the pattern image disposed on the surface of the image support to the transparent substrate to form a fluorescent body layer on each region on the substrate partitioned by the light-shielding layer; and
forming a metal back layer on the fluorescent body layer.

24. The method of producing a display device according to claim 23, further comprising drying the pattern image formed on the surface of the image support before the transferring.

25. The method of producing a display device according to claim 23, further comprising wetting the surface of the transparent substrate with the insulation liquid before the transfer step.

26. The method of producing a display device according to claim 23, wherein the image support is provided with a pattern-like electrode layer to form the pattern image on the surface thereof.
